(19) United States
(12) Patent Application Publication
(10) Pub. No.: US 2024/0276999 A1
(43) Pub. Date: Aug. 22, 2024

(54) USING RIBULOSE-1,5-BISPHOSPHATE CARBOXYLATE-OXYGENASE (RUBISCO) ISOLATE AS A FAT BINDING AGENT

(71) Applicant: Plantible Foods Inc., San Marcos, CA (US)

(72) Inventors: Parker LEE, Poway, CA (US); Tony MARTENS FEKINI, Encinitas, CA (US); Nina CILLIERS, San Diego, CA (US)

(21) Appl. No.: 18/634,139

(22) Filed: Apr. 12, 2024

Related U.S. Application Data
(63) Continuation of application No. PCT/US2022/078017, filed on Oct. 13, 2022.
(60) Provisional application No. 63/255,045, filed on Oct. 13, 2021.

(51) Int. Cl. A23D 7/005; A23D 7/01; A23J 3/14; A23J 3/22

(52) U.S. Cl. CPC A23D 7/0053; A23D 7/011; A23J 3/14; A23J 3/227

(57) ABSTRACT

Compositions comprising plant-based compositions and food products are described herein. The plant-based compositions and food products include a protein isolate, a food additive, and optionally a food component. The food additive optionally includes a plasticizer, an oil, a flavoring component, a surfactant and/or a coloring component. The protein isolate comprises a ribulose-1,5-bisphosphate carboxylase/oxygenase (RuBisCO) protein isolate. In some cases, compositions described herein include emulsions comprising a RuBisCO protein isolate extracted from Lemna minor, optionally wherein the RuBisCO protein isolate is comprised in an oil-in-water emulsion.

### CROSS-REFERENCE

This application claims the benefit of U.S. Provisional Application No. 63/255,045, filed on Oct. 13, 2021, and of PCT International Patent Application No. PCT/US2022/078017, filed Oct. 13, 2022, which are incorporated herein by reference in their entirety.

### INCORPORATION BY REFERENCE OF SEQUENCE LISTING

The instant application contains a Sequence Listing, which has been submitted via Patent Center. The Sequence Listing titled “200834_703301_SL.xml”, which was created on Apr. 3, 2024 and is 12,887 bytes in size, is hereby incorporated by reference in its entirety.

### BACKGROUND

Animal-based sources of protein are known to be associated with environmental risk from their caretaking and health risks to consumers, among other concerns. Thus, there is a need for alternative sources of protein, including sources which replace the saturated fat or saturated fat forming elements associated with meat-based sources of protein. In addition, for plant-based protein compositions destined for incorporation in food products, there is a need for improved emulsion capabilities where such animal-based fats are removed.

### BRIEF SUMMARY

Provided herein are compositions, wherein the compositions comprise water-in-oil water-in-oil emulsion particles, wherein the water-in-oil emulsion particles comprise: a protein isolate, wherein a majority of the protein in the isolate is ribulose-1,5-bisphosphate carboxylase/oxygenase (RuBisCO) protein isolate; a lipid; an aqueous liquid; and a surfactant. Further provided herein are compositions, wherein the emulsifier comprises a plant-based surfactant. Further provided herein are compositions, wherein the emulsifier comprises lecithin. Further provided herein are compositions, wherein the lecithin is from soybean, sunflower, and rapeseed. Further provided herein are compositions, wherein the lecithin is present in an amount of up to about 2% by weight. Further provided herein are compositions, wherein the lecithin is present in an amount of up to 1% by weight. Further provided herein are compositions, wherein the water-in-oil emulsion particles comprises an average zeta potential surface charge more negative than at least about −30 mV. Further provided herein are compositions, wherein the water-in-oil emulsion particles comprises an average zeta potential surface charge of −20 mV to −35 mV. Further provided herein are compositions, wherein the water-in-oil emulsion particles comprise an average diameter of up to about 10 μm. Further provided herein are compositions, wherein the water-in-oil emulsion particles comprise an average diameter of about 1 to about 5 μm. Further provided herein are compositions, wherein the lipid is in liquid phase at 25 degrees Celsius. Further provided herein are compositions, wherein the lipid comprises grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, or oil from beans. Further provided herein are compositions, wherein the lipid comprises coconut oil. Further provided herein are compositions, wherein the water-in-oil emulsion particles are in a ratio of lipid:aqueous liquid is at least 2:1 by weight. Further provided herein are compositions, wherein the water-in-oil emulsion particles are in a ratio of lipid:aqueous liquid is at least about 8:1 by weight. Further provided herein are compositions, wherein the RuBisCO is present in an amount of at least about 0.5% by dry weight. Further provided herein are compositions, wherein the protein isolate present in an amount of up to about 15% by dry weight. Further provided herein are compositions, wherein protein isolate is free of chlorophyll. Further provided herein are compositions, wherein the protein isolate is flavorless and colorless. Further provided herein are compositions, wherein the protein isolate comprises a large subunit and a small subunit of RuBisCO protein. Further provided herein are compositions, wherein the protein isolate comprises protein comprising a sequence at least 90% identical to any one of SEQ ID NO: 1 to SEQ ID NO: 10. Further provided herein are compositions, wherein the protein isolate comprises a protein comprising a sequence at least 95% identical to any one of SEQ ID NO: 1 to SEQ ID NO: 10. Further provided herein are compositions, wherein the protein isolate comprises a protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. Further provided herein are compositions, wherein the protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. Further provided herein are compositions, wherein the protein isolate comprises a RuBisCO protein large subunit. Further provided herein are compositions, wherein the protein isolate comprises a RuBisCO protein small subunit. Further provided herein are compositions, wherein the protein isolate is from a plant in the Lemna genus. Further provided herein are compositions, wherein the protein isolate is from a Lemna minor. Further provided herein are compositions, wherein the protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris. Further provided herein are compositions, wherein in the protein isolate is from a single plant species. Further provided herein are compositions, wherein the composition comprises a pH up to about 7.8. Further provided herein are compositions, further comprising a plasticizer. Further provided herein are compositions, wherein the plasticizer comprises a gum. Further provided herein are compositions, wherein the gum is gum Arabic, a xanthan gum, a guar gum, or a locust bean gum. Further provided herein are compositions, wherein the gum is xanthan gum. Further provided herein are compositions, wherein the aqueous liquid is water. Further provided herein are compositions, wherein the aqueous liquid comprises water and one or more acids. Further provided herein are compositions, wherein the one or more acids comprises citric acid and/or ascorbic acid. Further provided herein are compositions, wherein the composition is a food composition. Provided herein are methods of manufacturing a food product, comprising mixing the composition with another ingredient.

Provided herein are plant-based food products comprising: a protein isolate; and a food additive. Further provided herein are plant-based food products, wherein the food additive is selected from the group consisting of: a plasticizer, an oil, a flavoring component, and a coloring component. Further provided herein are plant-based food products, wherein the plasticizer comprises water. Further provided herein are plant-based food products, wherein the oil is selected from the group consisting of: a coconut oil, a safflower oil, a grapeseed oil, and a canola oil. Further provided herein are plant-based food products, wherein the flavoring component is selected from the group consisting of: a paprika flavoring component, an onion powder flavoring component, a garlic powder flavoring component, a beet powder flavoring component, and a liquid smoke flavoring component. Further provided herein are plant-based food products, wherein the protein isolate comprises a ribulose-1,5-bisphosphate carboxylase/oxygenase (RuBisCO) protein isolate. Further provided herein are plant-based food products, wherein the RuBisCO protein isolate comprises a protein content greater than approximately 80%. Further provided herein are plant-based food products, wherein the RuBisCO protein isolate is free of chlorophyll. Further provided herein are plant-based food products, wherein the RuBisCO protein isolate is flavorless and colorless. Further provided herein are plant-based food products, wherein the RuBisCO protein isolate is extracted from Lemna minor. Further provided herein are plant-based food products, further comprising: a food component. Further provided herein are plant-based food products, wherein the food component is selected from the group consisting of: a gluten, a yeast, a stock, a sauce, a syrup, a mustard, a paste, and a butter. Further provided herein are plant-based food products, wherein the plant-based food product comprises an emulsion. Further provided herein are plant-based food products, wherein the plant-based food product comprises a water-in-oil emulsion. Further provided herein are plant-based food products, wherein the water-in-oil emulsion comprises an aqueous phase optionally comprising a polysaccharide. Further provided herein are plant-based food products, wherein the emulsion comprises an oil phase comprising a ratio by weight of about 1:1 RuBisCO protein isolate:lecithin. Further provided herein are plant-based food products, wherein the emulsion a ratio of 90 weight percent oil and 10 weight percent water. Further provided herein are plant-based food products, wherein the 10 weight percent water comprises at least one polysaccharide. Further provided herein are plant-based food products, wherein the emulsion is implemented into a meat structure in a liquid or solid form to generate a fat structure. Further provided herein are plant-based food products, wherein the plant-based food product fails to comprise chemically modified polysaccharides or saturated fats. Provided herein are methods of manufacturing a food product, comprising mixing the plant-based food product with another ingredient.

Provided here are compositions, wherein the compositions comprise an oil-in-water emulsions, wherein the oil-in-water emulsion comprises: a protein isolate, wherein a majority of the protein in the isolate is ribulose-1,5-bisphosphate carboxylase/oxygenase (RuBisCO) protein isolate; a lipid; an aqueous liquid; a polysaccharide; and a surfactant. Further provided herein are compositions, wherein the emulsifier comprises a plant-based surfactant. Further provided herein are compositions, wherein the emulsifier comprises lecithin. Further provided herein are compositions, wherein the lecithin is from soybean, sunflower, and rapeseed. Further provided herein are compositions, wherein the lecithin is present in an amount of up to about 2% by weight. Further provided herein are compositions, wherein the lecithin is present in an amount of up to 1% by weight. Further provided herein are compositions, wherein the oil-in-water emulsion particles comprises an average zeta potential surface charge more negative than at least about −30 mV. Further provided herein are compositions, wherein the oil-in-water emulsion particles comprises an average zeta potential surface charge of −30 mV to −40 mV. Further provided herein are compositions, wherein the oil-in-water emulsion particles comprise an average diameter of up to about 10 μm. Further provided herein are compositions, wherein the oil-in-water emulsion particles comprise an average diameter of about 1 to about 5 μm. Further provided herein are compositions, wherein the lipid is in liquid phase at 25 degrees Celsius. Further provided herein are compositions, wherein the lipid comprises grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, or oil from beans. Further provided herein are compositions, wherein the lipid comprises coconut oil. Further provided herein are compositions, wherein the oil-in-water emulsion particles are in a ratio of lipid:aqueous liquid is at least 1:4 by weight. Further provided herein are compositions, wherein the oil-in-water emulsion particles are in a ratio of lipid:aqueous liquid is at least about 1:5 by weight. Further provided herein are compositions, wherein the RuBisCO is present in an amount of at least about 0.5% by dry weight. Further provided herein are compositions, wherein the protein isolate present in an amount of up to about 15% by dry weight. Further provided herein are compositions, wherein protein isolate is free of chlorophyll. Further provided herein are compositions, wherein the protein isolate is flavorless and colorless. Further provided herein are compositions, wherein the protein isolate comprises a large subunit and a small subunit of RuBisCO protein. Further provided herein are compositions, wherein the protein isolate comprises protein comprising a sequence at least 90% identical to any one of SEQ ID NO: 1 to SEQ ID NO: 10. Further provided herein are compositions, wherein the protein isolate comprises a protein comprising a sequence at least 95% identical to any one of SEQ ID NO: 1 to SEQ ID NO: 10. Further provided herein are compositions, wherein the protein isolate comprises a protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. Further provided herein are compositions, wherein the protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. Further provided herein are compositions, wherein the protein isolate comprises a RuBisCO protein large subunit. Further provided herein are compositions, wherein the protein isolate comprises a RuBisCO protein small subunit. Further provided herein are compositions, wherein the protein isolate is from a plant in the Lemna genus. Further provided herein are compositions, wherein the protein isolate is from a Lemna minor. Further provided herein are compositions, wherein the protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris. Further provided herein are compositions, wherein in the protein isolate is from a single plant species. Further provided herein are compositions, wherein the composition comprises a pH up to about 7.8. Further provided herein are compositions, further comprising a plasticizer. Further provided herein are compositions, wherein the plasticizer comprises a gum. Further provided herein are compositions, wherein the gum is gum Arabic, a xanthan gum, a guar gum, or a locust bean gum. Further provided herein are compositions, wherein the gum is xanthan gum. Further provided herein are compositions, wherein the aqueous liquid is water. Further provided herein are compositions, wherein the aqueous liquid comprises water and one or more acids. Further provided herein are compositions, wherein the one or more acids comprises citric acid and/or ascorbic acid. Further provided herein are compositions, wherein the aqueous liquid comprises water and one or more salts. Further provided herein are compositions, wherein the one or more salts are selected from potassium in the form of potassium chloride, and calcium in the form of calcium chloride. Further provided herein are compositions, wherein the aqueous liquid comprises a polysaccharide. Further provided herein are compositions, wherein the polysaccharide is selected from konjac-xanthum, a konjac-xanthum blend, pectin, guar k-carageenan, and curdlan. Further provided herein are compositions, wherein the polysaccharide is present in an amount of about 1% to 5% of polysaccharide. Further provided herein are compositions, wherein the RuBisCO protein isolate is in an amount of 0.5% weight. Further provided herein are compositions, wherein the compositions comprise or is a food composition. Further provided herein are methods of manufacturing a food product, the method comprising mixing the composition of any of the above with another ingredient.

Provided herein are plant-based food products comprising an emulsion, wherein the emulsion comprises: a protein isolate; a polysaccharide; and a food additive. Further provided herein are plant-based food products, wherein the food additive is selected from the group consisting of: a plasticizer, an oil, a flavoring component, and a coloring component. Further provided herein are plant-based food products, wherein the plasticizer comprises water. Further provided herein are plant-based food products, wherein the oil is selected from the group consisting of: a coconut oil, a safflower oil, a grapeseed oil, and a canola oil. Further provided herein are plant-based food products, wherein the flavoring component is selected from the group consisting of: a paprika flavoring component, an onion powder flavoring component, a garlic powder flavoring component, a beet powder flavoring component, and a liquid smoke flavoring component. Further provided herein are plant-based food products, wherein the protein isolate comprises a ribulose-1,5-bisphosphate carboxylase/oxygenase (RuBisCO) protein isolate. Further provided herein are plant-based food products, wherein the RuBisCO protein isolate comprises a protein content greater than approximately 80%. Further provided herein are plant-based food products, wherein the RuBisCO protein isolate is free of chlorophyll. Further provided herein are plant-based food products, wherein the RuBisCO protein isolate is flavorless and colorless. Further provided herein are plant-based food products, wherein the RuBisCO protein isolate is extracted from Lemna minor. Further provided herein are plant-based food products, further comprising: a food component. Further provided herein are plant-based food products, wherein the food component is selected from the group consisting of: a gluten, a yeast, a stock, a sauce, a syrup, a mustard, a paste, and a butter. Further provided herein are plant-based food products, wherein the plant-based food product comprises an oil-in-water emulsion. Further provided herein are plant-based food products, wherein the oil-in-water emulsion comprises an aqueous phase optionally comprises a polysaccharide. Further provided herein are plant-based food products, wherein the emulsion comprises an oil phase comprising a ratio by weight of about 1:1 RuBisCO protein isolate:lecithin. Further provided herein are plant-based food products, wherein the emulsion a ratio of 90 weight percent oil and 10 weight percent water. Further provided herein are plant-based food products, wherein the 10 weight percent water comprises at least one polysaccharide. Further provided herein are plant-based food products, wherein the aqueous liquid comprises water and one or more salts. Further provided herein are plant-based food products, wherein the one or more salts are selected from potassium in the form of potassium chloride, and calcium in the form of calcium chloride. Further provided herein are plant-based food products, wherein the aqueous liquid comprises a polysaccharide. Further provided herein are plant-based food products, wherein the polysaccharide is selected from konjac-xanthum, a konjac-xanthum blend, pectin, guar k-carageenan, and curdlan. Further provided herein are plant-based food products, wherein the polysaccharide is present in an amount of about 0.5% to 5% of polysaccharide. Further provided herein are plant-based food products, wherein the RuBisCO protein isolate is in an amount of 0.5% weight. Further provided herein are plant-based food products, wherein the emulsion is implemented into a meat structure in a liquid or solid form to generate a fat structure. Further provided herein are methods of manufacturing a food product, the method comprising mixing the plant-based food product of any of the above with another ingredient.

In some embodiments, a composition herein comprises an emulsion, wherein the emulsion is an oil-in-water emulsion, and wherein the emulsion comprises: 50-85% water by weight; up to about 5% polysaccharide by weight; 15-25% coconut oil by weight; up to about 15% lecithin by weight; and up to about 15% RuBisCO protein isolate by weight. In some embodiments, the emulsion is an oil-in-water emulsion, and the emulsion comprises: about 85% water by weight; up to about 0.1% polysaccharide by weight; about 25% coconut oil by weight; up to about 0.1% lecithin by weight; and up to about 0.1% RuBisCO protein isolate by weight. In some embodiments, the emulsion is an oil-in-water emulsion, the polysaccharide comprises konjac-xanthan, and the emulsion comprises: 79.8% water by weight; up to about 0.2% konjac-xanthan by weight; 19.5% coconut oil by weight; up to about 0.25% lecithin by weight; and up to about 0.25% RuBisCO protein isolate by weight. In some embodiments, the emulsion is an oil-in-water emulsion, the polysaccharide comprises curdlan, and the emulsion comprises: 79.8% water by weight; up to about 1% curdlan by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises agar, and the emulsion comprises: about 79.8% water by weight; up to about 1% agar by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises pectin, and the emulsion comprises: about 79.8% water by weight; up to about 0.8% pectin by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises kappa carrageenan, and the emulsion comprises: about 79.8% water by weight; up to about 0.8% kappa carrageenan by weight; 19.5% coconut oil by weight; up to about 0.25% lecithin by weight; and up to about 0.25% RuBisCO protein isolate by weight. In some embodiments, are food products comprising an emulsion described herein. In some embodiments, are methods of manufacturing a food product, the method comprising mixing the composition or the plant-based food product described above with another ingredient.

Provided here is the use of a RuBisCo isolate as a fat binding agent, including for use in a plant-based food product. Further provided herein are compositions, wherein the plant-based food product includes at least a protein isolate and a food additive Further provided herein are compositions, wherein the food additive includes a plasticizer, an oil, a flavoring component, and/or a coloring component. Further provided herein are compositions, wherein the plasticizer comprises water. Further provided herein are compositions further comprising an oil. Further provided herein are compositions, wherein the oil comprises a safflower oil, a grapeseed oil, or a canola oil, among others. Further provided herein are compositions, wherein the flavoring component comprises a paprika powder flavoring component, an onion powder flavoring component, a garlic powder flavoring component, a beet powder flavoring component, or a liquid smoke flavoring component. Further provided herein are compositions, wherein the protein isolate comprises a RuBisCo protein isolate. Further provided herein are compositions, wherein the RuBisCo protein isolate is extracted from Lemna minor. Further provided herein are compositions, wherein the RuBisCo protein isolate comprises a protein content greater than about 80%. Further provided herein are compositions, wherein the RuBisCo protein isolate comprises a protein content greater than about 55, 60, 65, 70, or 75% RuBisCo. Further provided herein are compositions, wherein the RuBisCo protein isolate is free of chlorophyll, is flavorless and is colorless. Further provided herein are compositions, wherein the compositions are part of a plant-based food product further comprising a food component. Further provided herein are compositions, wherein the food component comprises gluten, a yeast, a stock, a sauce, a syrup, a mustard, a paste, and/or a butter, among others. Further provided herein are compositions, wherein the plant-based food product comprises an emulsion. Further provided herein are compositions, wherein the emulsion is implemented into a meat structure in a liquid or solid form to generate a fat or fat-like structure. Further provided herein are compositions, wherein fat-like structure may mimic biochemical, textural, physical, or other characteristics of fat structure in meat.

### BRIEF DESCRIPTION OF THE DRAWINGS

The preferred embodiments of the present disclosure will now be described with reference to the drawings. Identical elements in the various figures are identified with the same reference numerals. Reference will now be made in detail to each embodiment of the present disclosure. Such embodiments are provided by way of explanation of the present disclosure, which is not intended to be limited thereto. In fact, those of ordinary skill in the art may appreciate upon reading the present specification and viewing the present drawings that various modifications and variations can be made thereto.

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 depicts a block diagram of components of a plant-based food product, according to at least some embodiments disclosed herein.

FIG. 2 depicts an image of a plant-based food product using a safflower oil emulsion, according to at least some embodiments disclosed herein.

FIG. 3 depicts another image of a plant-based food product using a safflower oil emulsion, according to at least some embodiments disclosed herein.

FIG. 4 depicts another image of a plant-based food product using a safflower oil emulsion, according to at least some embodiments disclosed herein.

FIG. 5 depicts an image of a plant-based marbled steak food product, according to at least some embodiments disclosed herein.

FIG. 6 depicts another image of a plant-based marbled steak food product, according to at least some embodiments disclosed herein.

FIG. 7 depicts an image of a plant-based lardons/bacon food product, according to at least some embodiments disclosed herein.

FIG. 8 depicts another image of a plant-based lardons/bacon food product, according to at least some embodiments disclosed herein.

FIG. 9 depicts another image of a plant-based lardons/bacon food product, according to at least some embodiments disclosed herein.

FIGS. 10A-10B depict a graphical representations of particle size distributions measured by droplet size in micrometers for 2 parts canola oil to 1 part water emulsions comprising 0.5% RuBisCO in the aqueous phase (FIG. 10A), and 15% RuBisCO in the aqueous phase (FIG. 10B). Higher concentration oil-in-water RuBisCO emulsions showed a reduction in average droplet size and broader size distribution in comparison to the low concentration RuBisCO emulsion.

FIG. 11 depicts a graphical representation of average droplet size distributions for various RuBisCO emulsions as a function of the RuBisCO concentration of each emulsion (weight % of the aqueous phase) in a 2 parts canola oil to 1 part water emulsion.

FIGS. 12A-12B depict images of cooked RuBisCO emulsions comprising 2 parts oil to 1 part water, showing that viscosity and yielding of the cooked emulsion increases with RuBisCO concentration. FIG. 12A depicts an image of a steamed 5% RuBisCO (by weight % of the aqueous phase) emulsion. FIG. 12B depicts an image of a steamed 15% RuBisCO (by weight % of the aqueous phase) emulsion.

FIGS. 13A-13B depict magnified images of 15% RuBisCO emulsions comprising 2 parts oil to 1 part water, where the emulsions were steamed at 90 degrees Celsius for 30 minutes, cooled to room temperature, and then were analyzed under magnification at 100-times magnification (FIG. 13A), and 10-times magnification (FIG. 13B).

FIG. 14 shows a graphical representation of texture analysis using stress (Pascals) (y-axis) as a function of displacement (x-axis) as strain. Compressive stress was measured as a function of strain on steamed RuBisCO emulsions from Example 11. Strain is calculated by normalizing the measured displacement by the sample heights. The 15% RuBisCO emulsion (upper data series) demonstrated a gradual increase in stress as pressure was applied to the sample across approximately 0.275. The 0.5% RuBisCO emulsion demonstrated a lack of formed texture in comparison to the 15% RuBisCO emulsion.

FIG. 15 shows a magnified image of a water-in-oil RuBisCO emulsion comprising 90% coconut oil and 10% water at 5% RuBisCO concentration (% weight in the aqueous phase) also comprising an amount of lecithin (0.5% by weight in the aqueous phase).

FIGS. 16A-16B show graphical representations of fat mimetics and their mechanical response to deformation in the form of the complex modulus (G*) at different temperatures.

FIGS. 17A-17B shows graphical representations of the mechanical response to deformation in the form of the complex modulus (G*) (FIG. 17A) and liquid or solid character in the form of tan(d) (FIG. 17B) of oil-in-water containing emulsions prepared with different polysaccharides.

FIGS. 18A-18B shows images of 2% lecithin in aqueous RuBisCO solutions before (FIG. 18A) and after (FIG. 18B) filtration with a 0.22 μM syringe filter. The large specks visible in FIG. 18A indicate that lecithin was not fully soluble at 2% in water.

FIGS. 19A-19C shows magnified images of water-in-oil RuBisCO emulsions containing 0.5%, 1%, or 2% lecithin (FIG. 19A, FIG. 19B, FIG. 19C, respectively) in the aqueous phase of each 90% oil, 10% water emulsion.

FIG. 20 shows a magnified image (10-times magnification) of the microstructure of a water-in-oil emulsion comprising 10% water (containing 0.5% by weight lecithin) with 90% canola oil (containing 0.5% by weight RuBisCO).

FIGS. 21A-21C shows images of oil-in-water emulsions without RuBisCO comprising 0.5% lecithin, approximately 80% water, 0.2% Konjac-Xanthan, and approximately 20% coconut oil. FIG. 21A shows the oil-in-water emulsion prior to melting. FIGS. 21B-21C show the oil-in-water emulsion after melting.

FIGS. 22A-22B shows images of oil-in-water RuBisCO emulsions comprising 0.25% lecithin, 0.25% RuBisCO, approximately 80% water, 0.2% Konjac-Xanthan, and approximately 20% coconut oil. FIG. 22A shows the oil-in-water RuBisCO emulsion prior to melting. FIG. 22B shows the oil-in-water RuBisCO emulsion after melting.

### DETAILED DESCRIPTION

### Definitions

Unless defined otherwise, all technical and scientific terms used herein have the same meaning as commonly understood by those of ordinary skill in the art to which embodiments herein belongs. The following definitions are provided to facilitate understanding of certain terms used frequently herein and are not meant to limit the scope of the present disclosure.

As used herein, an “embodiment” means that a particular feature, structure or characteristic is included in at least one or more manifestations, examples, or implementations of this disclosure. Furthermore, the particular features, structures or characteristics may be combined in any suitable manner, as would be apparent to a person skilled in the art. Combinations of features of different embodiments are all meant to be within the scope of the invention, without the need for explicitly describing every possible permutation by example. Thus, any of the claimed embodiments can be used in any combination. Furthermore, reference herein to “some embodiments,” “an embodiment,” “one embodiment” or “other embodiments” means that a particular feature, structure, or characteristic described in connection with the embodiments can be included in at least some embodiments, but not necessarily all embodiments, of the present disclosure.

Herein, the use of the singular includes the plural unless specifically stated otherwise. It must be noted that, as used in the specification, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

Unless specifically stated or obvious from context, as used herein, the term “about” as used herein when referring to a measurable value such as an amount or time period and the like refers to variations of +20%, which is inclusive of +10%, +5%, +1%, +0.5%, and +0.1% of the specified amount. As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

Herein, the use of “or” means “and/or” unless stated otherwise. The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. The terms “and/or” and “any combination thereof” and their grammatical equivalents as used herein, can be used interchangeably. These terms can convey that any combination is specifically contemplated. Solely for illustrative purposes, the following phrases “A, B, and/or C” or “A, B, C, or any combination thereof” can mean “A individually; B individually; C individually; A and B; B and C; A and C; and A, B, and C.” The term “or” can be used conjunctively or disjunctively, unless the context specifically refers to a disjunctive use.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps. It is contemplated that any embodiment discussed in this specification can be implemented with respect to any method or composition of the present disclosure, and vice versa. Furthermore, compositions of the present disclosure can be used to achieve methods of the present disclosure.

As used herein, the term “emulsion” refers to a composition composed of discontinuous droplets of liquid suspended in a second immiscible liquid. An “oil-in-water” emulsion refers to oil droplets suspended in water, or an aqueous phase. The aqueous phase may further comprise additional materials or solutes. An “water-in-oil” emulsion refers to water droplets suspended in oil. As used herein, the water droplets can be droplets of any aqueous phase that may further comprise additional materials, surfactants or other solutes.

As used herein, “emulsion activity” is defined as the maximum amount of oil that can be emulsified by a fixed amount of the protein.

The ability of proteins to form gels and stable foams is important in the production of a variety of foods. As used herein, foams refer to structures formed by trapping pockets of gas in a liquid or solid. Proteins in foams contribute to the foam's ability to form small air cells and stability in holding the structure. Foams with a uniform distribution of small air bubbles impart body, smoothness and lightness to the food. The ability of a protein preparation to form a foam is related to its purity.

As used herein, gels are soft solids comprising a high amount of an aqueous phase. Protein gels may comprise a three-dimensional network of protein fibers with a continuous liquid phase throughout the matrix. Proteins with higher gelling capacity require less protein to form a gel. The processes disclosed herein may be used to prepare protein preparations with advantageously high purity, foaming capacity, foam stability, and gelling capacity that is suitable for use in food products.

As used herein, “identity,” refers to a relationship between two or more amino acid sequences, as determined by comparing the sequences. In the art, “identity” also refers to the degree of sequence relatedness between amino acid sequences as determined by the match between strings of such sequences. “Identity” can be readily calculated by known methods, including, but not limited to, those described in (Computational Molecular Biology, Lesk, A M., Ed., Oxford University Press, New York, 1988; Biocomputing: Informatics and Genome Projects, Smith, D. W., Ed., Academic Press, New York, 1993; Computer Analysis of Sequence Data, Part I, Griffin, A M., and Griffin, H. G., Eds., Humana Press, New Jersey, 1994; Sequence Analysis in Molecular Biology, von Heinje, G., Academic Press, 1987; and Sequence Analysis Primer, Gribskov, M. and Devereux, J., Eds., M Stockton Press, New York, 1991; and Carillo, H., and Lipman, D., SIAM J. Applied Math. 1988, 48: 1073. Preferred methods to determine identity are designed to give the largest match between the sequences tested. Methods to determine identity are codified in publicly available computer programs. The percent identity between two sequences can be determined by using analysis software (e.g., Sequence Analysis Software Package of the Genetics Computer Group, Madison Wis.) that incorporates the Needelman and Wunsch, (J. Mol. Biol., 1970, 48: 443-453,) algorithm (e.g., NBLAST, and XBLAST). The default parameters are used to determine the identity for the polypeptides of the present disclosure, unless stated otherwise.

As used herein, the term “protein” refers to a molecule comprised of amino acid residues, at least two of which are covalently linked by peptide bonds. A protein contains at least two amino acids or amino acid variants, and no limitation is placed on the maximum number of amino acids that can comprise a protein sequence. The term “protein isolate” refers to aa preparation of proteins, wherein the proteins has been substantially separated from non-protein components of a mixture. The “purity” of a protein isolate refers to the amount of protein relative to the total amount of protein preparation. In some embodiments, the purity of the protein isolate is expressed as a percentage of the total dry mass.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of about 0.1% to about 5%” should be interpreted to include not only the explicitly recited values of about 0.1% to about 5%, but also, unless otherwise stated, include individual values (e.g., about 1%, about 2%, about 3%, about 4%, etc.) and the sub-ranges (e.g., about 0.5% to about 1.1%; about 0.5% to about 2.4%; about 0.5% to about 3.2%, about 0.5% to about 4.4%, and other possible sub-ranges, etc.) within the indicated range.

As used herein, the term “substantially free” refers to less than 5% of a measurable value.

### Plant Based Protein Isolates

Provided herein are compositions, wherein the compositions comprise protein isolate and processes for making protein isolate compositions from plant material. In certain embodiments, the protein isolate comprises ribulose-1,5-bisphosphate carboxylase/oxygenase (RuBisCO) protein. In some embodiments, the protein isolate is at least about 50, 55, 60, 65, 70, 75, 80, 85, 90, 95% or more pure. In some embodiments, the RuBisCO in the protein isolate is at least about 50, 55, 60, 65, 70, 75% or more of the protein isolate. In some embodiments, the RuBisCO in the protein isolate is 60% to 80%, 60% to 70%, or 60% to 75% of the protein isolate. For some plants, a majority of the protein is RuBisCO. Furthermore, using purification processes described herein, in some embodiments the protein isolate generated is free of chlorophyll, is flavorless, and/or is colorless. In some embodiments, a compositions comprising the RuBisCO protein isolate. In some embodiments the compositions comprising the RuBisCO protein isolate are RuBisCO protein isolate compositions. In some embodiments, compositions comprising the RuBisCO protein isolate further comprise an additive. In some embodiments, compositions comprising the RuBisCO protein isolate comprise an emulsion. In some embodiments, the subject matter described herein includes a plant-based emulsion food product that includes a protein isolate, a food component, and a food additive. In some embodiments the emulsion comprises emulsion particles. In some embodiments the emulsion comprises oil-in-water emulsion particles. In some embodiments, the emulsion comprises water-in oil emulsion particles. In some embodiments the RuBisCO protein isolate is in the oil phase. In some embodiments the RuBisCO protein isolate is in the aqueous, or water phase. In some embodiments, the emulsion comprises more than one oil. In some embodiments, the emulsion particles comprise the droplets of the suspended phase in the immiscible continuous phase.

In some embodiments, the emulsion particles comprise an average diameter of about 0.01 μm to 0.1 μm, about 0.1 μm to 0.25 μm, about 0.25 μm to 0.5 μm, about 0.5 μm to 0.75 μm, about 0.75 μm to 1.0 μm, about 1.0 μm to 1.5 μm, about 1.5 μm to 2.0 μm, about 2.0 μm to 2.5 μm, about 2.5 μm to 3.0 μm, about 3.0 μm to 3.5 μm, about 3.5 μm to 4.0 μm, about 4.0 μm to 4.5 μm, about 4.5 μm to 5.0 μm, about 5.0 μm to 5.5 μm, about 5.5 μm to 6.0 μm, about 6.0 μm to 6.5 μm, about 6.5 μm to 7.0 μm, about 7.0 μm to 7.5 μm, about 7.5 μm to 8.0 μm, about 8.0 μm to 8.5 μm, about 8.5 μm to 9.0 μm, about 9.0 μm to 9.5 μm, or about 9.5 μm to 10.0 μm.

In some embodiments, the emulsion particles comprise an average diameter of up to about 0.01 μm, about 0.1 μm, about 0.25 μm, about 0.5 μm, about 0.75 μm, about 1.0 μm, about 1.5 μm, about 2.0 μm, about 2.5 μm, about 3.0 μm, about 3.5 μm, about 4.0 μm, about 4.5 μm, about 5.0 μm, about 5.5 μm, about 6.0 μm, about 6.5 μm, about 7.0 μm, about 7.5 μm, about, 8.0 μm, about 8.5 μm, about 9.0 μm, about 9.5 μm, or about 10.0 μm.

In some embodiments, the emulsion has a pH from about 5 to about 9, from about 5 to about 8, from about 5 to about 7, from about 6 to about 9, from about 6 to about 8, or from about 6 to about 7.

The emulsions described herein can be used in the production of cosmetics, cosmeceuticals, pharmaceuticals, nutraceuticals, supplements, food products, food, beverages, and the like. In some cases, the disclosed compositions can emulate, mimic, or simulate one or more qualities of a fat binding agent, fat substitute, fat replacement, or fat mimic. Natural fat can include binding, moisturizing, leavening, emulsifying, gelling, pH, viscosity, thickening, solubility, and textural characteristics. Compositions described herein can comprise a surfactant. As used herein, the terms, “surfactant” and “emulsifier” can be used interchangeably.

In some embodiments, the compositions described herein include binding, moisturizing, leavening, emulsifying, gelling, pH, viscosity, thickening, solubility, and/or textural characteristics. Other qualities include benefits that can be derived from consuming or otherwise using natural fat, or fat-containing products, such as protein content, lipid content, enzymatic activity, nutrients (e.g., essential amino acids), and the like. Accordingly, the compositions disclosed herein can be used to supplement, replace some of, or substitute for the use of natural eggs and/or dairy in cosmetics, cosmeceuticals, pharmaceuticals, nutraceuticals, supplements, food products, food, beverages, amongst other fat or butter-like containing products.

The food additive may be a plasticizer, an oil, a sugar, a flavoring component, a coloring component, a fiber, a soluble salt, a starch, an acid, and/or a wax, among others not explicitly listed herein. The plasticizer may be water, an aqueous polysaccharide solution, an alcohol, a polyalcohol, a glycerol (glycerine), a gum Arabic, a xanthan gum, a guar gum, a locust bean gum, and/or an aqueous solution of carbohydrates, among others not explicitly listed herein. Further, the coloring component may be a turmeric component, among others not explicitly listed herein.

Additionally, the fiber may be pectin, citrus fiber, and/or cellulose, among others not explicitly listed herein. In some examples, the soluble salt may be calcium lactate gluconate, among others not explicitly listed herein. In other examples, the acid may be ascorbic acid and/or citric acid, among others not explicitly listed herein. The oil may be a safflower oil, a coconut oil, a grapeseed oil, and/or a canola oil, among others not explicitly listed herein. Further, the wax may be a naturally-derived wax or a synthetic wax.

In some embodiments, compositions described herein are food products comprising plant-based ingredients for a majority or all of the ingredients. In some embodiments, the plant-based food product comprises or is an emulsion. The emulsion may be used as a fat additive, fat substitute, or fat mimic. In some embodiments the plant-based food is spreadable. In some embodiments, the compositions comprising RuBisCO protein isolate are in the form of an emulsion or multiple emulsions. An emulsion described herein is a mixture of two or more liquids, or liquid components that are normally immiscible, or unable to be blended due to liquid-liquid phase separation. As used herein, a liquid in an emulsion can further comprise solutes. In some embodiments the solute is RuBisCO protein isolate. In some embodiments, the solute is an additive, a polysaccharide, and emulsifier, a plasticizer, or other food product ingredient. In some embodiments, a solute may precipitate out of an emulsion. In some embodiments, the compositions comprising RuBisCO protein isolate are in the form of emulsion particles. In some embodiments, the emulsion is a stable dispersion where two liquids are suspended by one or more emulsifiers. In some embodiments, RuBisCO protein isolate is an emulsifier. In some embodiments, lecithin is an emulsifier. In some embodiments, an emulsion described herein comprises equal amounts of RuBisCO protein isolate and lecithin. In some embodiments, the emulsion is an oil-in-water emulsion. In some embodiments, the emulsion is a water-in-oil emulsion. In some embodiments, the water in an oil-in-water emulsion comprises one or more solutes. In some embodiments, the water in a water-in-oil emulsion comprises one or more solutes. In some embodiments the ratio of oil to water is about 0:100, about 1:99, about 5:95, about 10:90, about 15:85, about 20:80, about 25:75, about 30:70, about 35:65, about 40:60, or about 45:55. In some embodiments the ratio of water to oil is about 0:100, about 1:99, about 5:95, about 10:90, about 15:85, about 20:80, about 25:75, about 30:70, about 35:65, about 40:60, or about 45:55.

In some embodiments the emulsions further comprise a plasticizer, emulsifier, additive, or a combination thereof. In some embodiments the emulsion has a particular texture. In some embodiments the texture may change due to heating, steaming, or due to a combination of both. In some embodiments, the emulsion is cooked. In some embodiments, the emulsion is spreadable. In some embodiments the emulsion has a particular viscosity. In some embodiments the viscosity of the emulsion resembles a flan, a cream cheese, a butter, a batter, or a combination thereof. In some embodiments, texture analysis in carried out by evaluating strain. Strain is determined by measuring stress as a function of displacement of the emulsion. Compressive stress can be calculated as a function of strain on emulsions described herein. Strain can be calculated by normalizing the measured displacement by sample heights.

Methods and compositions for producing plant-based food products are described herein. In some examples, the plant-based food products are non-animal-based replicas of animal-based food products. In other examples, the plant-based food products act as nutraceuticals or carriers for pharmaceutical compositions. In some examples, the plant-based food products may be for human consumption. In other examples, the plant-based food products may be for animal consumption, such as for domesticated or wild animals.

### Plant-Based Food Products

Methods and compositions for producing plant-based food products are described herein. In some examples, the plant-based food products are non-animal based replicas of animal-based food products. In other examples, the plant-based food products act as nutraceuticals or carriers for pharmaceutical compositions. In some examples, the plant-based food products may be for human consumption. In other examples, the plant-based food products may be for animal consumption, such as for domesticated or wild animals.

In other examples, the plant-based food products are made to replicate food products, such as to produce an equivalent meat product. The equivalent meat product can be derived from any animal, such as cattle, sheep, pig, chicken, turkey, goose, duck, horse, dog, rabbit, deer, bison, buffalo, boar, snake, pheasant, quail, bear, elk, antelope, pigeon, dove, grouse, fox, wild pig, goat, kangaroo, emu, alligator, crocodile, turtle, groundhog, marmot, possum, partridge, squirrel, raccoon, whale, seal, ostrich, capybara, nutria, guinea pig, rat, mice, vole, any variety of insect or other arthropod, or seafood. Examples of plant-based food products created may include any plant-based food product, including, but not limited to drinks, meats, cheeses, eggs, pastes, pate, etc. The plant-based meat product may be a meat replica and may be made to mimic the look, texture, and taste of the animal-based product, such that is similar to, or indistinguishable from, the given food product.

In examples described herein, the plant-based food product includes one or more protein isolates, where “protein isolate” indicates that the protein content is greater than about 80%, 85%, 90%, or 95%. In other examples, the plant-based food product described herein includes one or more isolated and purified proteins. As described herein, “isolated and purified protein” refers to a preparation where the cumulative abundance by mass of protein components other than the specified protein, which can be a single monomeric or multimeric protein species, is reduced by a factor of 2 or more, 3 or more, 5 or more, 10 or more, 20 or more, 50 or more, 100 or more or 1000 or more relative to the source material from which the specified protein was isolated. The isolated and purified protein is described as isolated and purified relative to its starting material (e.g., plants or other non-animal sources). In some embodiments, the term “isolated and purified” can indicate that the preparation of the protein is at least 60% pure, e.g., greater than 65%, 70%, 75%, 80%, 85%, 90%, 95%, or 99% pure. The isolated and purified protein or the protein isolate may be derived from a non-animal source, such as plants, algae, fungi (e.g., yeast or filamentous fungi), bacteria, or Archaea.

### Ribulose-1,5-Bisphosphate Oxygenase (RuBisCO)

Disclosed herein are ribulose-1,5-bisphosphate carboxylase/oxygenase (RuBisCO) protein isolate compositions and processes for making RuBisCO compositions. In some embodiments, the disclosed compositions and methods relate to the use of RuBisCO protein isolates for plant-based food products, such as plant-based fat replacement products and plant-based butter, dairy, or milk replacement products.

RuBisCO is considered the most abundant plant protein known and is an enzyme involved in the first major step of carbon fixation, a process by which the atmospheric carbon dioxide is converted by plants and other photosynthetic organisms to energy-rich molecules such as glucose. More specifically, RuBisCO catalyzes the carboxylation of ribulose-1,5-bisphosphate (or “RuBP”).

In some embodiments, RuBisCO proteins are extracted from a Lemna plant. In some embodiments, the Lemna plant is Lemna minor. Lemna minor is a floating freshwater aquatic plant, with one, two, three, or four leaves, each having a single root hanging in the water. Lemna minor has a subcosmopolitan distribution and is native throughout most of Africa, Asia, Europe and North America. It is present wherever freshwater ponds and slow-moving streams occur, except for arctic and subarctic climates. Subsequent to extraction, RuBisCO proteins may be further processed to improve the purity of the protein sample. In other scenarios, the extracted RuBisCO may undergo further processing (e.g., adjusting the pH, adjusting the heat, etc.) in order to concentrate the extracted proteins. Additionally, extracted RuBisCO proteins may also be combined with other proteins, where such combination may occur before or after the additional processing described. In some examples, RuBisCO and additional proteins may be in a dry form (e.g., powdered, pelletized, or the like). In other examples, the RuBisCO and the additional proteins may be in a liquid form or in a liquid solution.

In some embodiments, a protein isolate is used as a surfactant in a composition described herein. In some embodiments, a protein isolate is used as an emulsifier in a composition described herein. In some embodiments, a protein isolate is used as a surfactant in a food product described herein. In some embodiments, a protein isolate is used as an emulsifier in a food product described herein. In some embodiments, a composition or food product described herein comprising a protein isolate as an emulsifier, further comprises a second emulsifier. In some embodiments, the second emulsifier is lecithin.

In some embodiments, RuBisCO protein isolate is used as a surfactant in a composition described herein. In some embodiments, RuBisCO protein isolate is used as an emulsifier in a composition described herein. In some embodiments, RuBisCO protein isolate is used as a surfactant in a food product described herein. In some embodiments, RuBisCO protein isolate is used as an emulsifier in a food product described herein. In some embodiments, a composition or food product described herein comprising a RuBisCO protein isolate as an emulsifier, further comprises a second emulsifier. In some embodiments, the second emulsifier is lecithin.

In some examples, the RuBisCO proteins may be combined with a plasticizer. As described herein, plasticizers are low molecular weight, non-volatile compounds used as additives or incorporated into other material in order to increase flexibility and dispensability. The process of plasticizing a protein-based polymer or fiber may be affected by the selected plasticizer's molecular weight, as well as the number and position of various hydroxyl groups. Examples of plasticizers include: water, an aqueous polysaccharide solutions, an alcohol, a polyalcohol, a glycerol (glycerine), a gum Arabic, a xanthan gum, a locust bean gum, and/or an aqueous solution of carbohydrates, among others not explicitly listed herein. An amount of the plasticizer added may vary between about 0.01% and about 10% depending on the amount of the protein.

Depending on the plasticizer used, the moisture content of the RuBisCO protein may require adjustment. In some embodiments the moisture content may range from about 15% to about 30%. The RuBisCO and additional proteins, in combination with the plasticizer, may be exposed to heat and thermally plasticized. The plasticizing process may require mechanical mixing, which may include any means known in the art.

In some embodiments, wax may also be added to the mixture to provide additional stability to the resulting fiber. The wax may include a naturally-derived wax or a synthetic wax. In further embodiments, the RuBisCO protein may be a RuBisCO protein isolate that comprises a protein content of greater than about 80%, a protein content of greater than about 85%, a protein content of greater than about 90%, or a protein content of greater than about 95%.

In some embodiments, the plant-based food product further includes a second isolated and purified protein, and/or a seasoning agent, a coloring agent, a flavoring agent, a gelling agent, a sugar, or a fiber.

In some embodiments, the plant-based food product further includes an emulsifier, a plasticizer, or both. In some embodiments, the emulsifier or plasticizer, or both, may be referred to as an “additive”. In some embodiments the additive is lecithin. Lecithin is a clean emulsifier. Lecithin can be used for the treatment of high cholesterol and/or digestive issues. Lecithin can also change the solubility of components in an emulsion. In some embodiments, lecithin is sometimes included in fat substitutes like vegan, butter-like spreads. In some embodiments, the inclusion of lecithin in RuBisCO-containing plant-based formulations provides for stable emulsions. In some embodiments, the emulsions described herein contain RuBisCO and lecithin. In some embodiments the emulsion is a water-in-oil emulsion. In some embodiments, the emulsion is an oil-in-water emulsion.

### Plant Protein Production and Isolation

In some embodiments, systems and methods described herein are useful for the production of a plant protein. In some embodiments, methods of plant production comprising RuBisCO. In some embodiments, provided herein are compositions comprising plant protein described herein.

Proteins can be extracted from aquatic biomass through any known processes, wherein aquatic biomass generally comprises plant material. For example, plant material containing protein, such as RuBisCO, can be homogenized and the protein extracted from the pulp and/or liquid. The extract can be further clarified, filtered, and washed to arrive at the described protein isolate. Other extraction processes can include solvent extraction (e.g., using polar solvents, organic solvents, or supercritical fluids), chromatography (e.g., preparative liquid chromatography), clarification, distillation, filtration (e.g., ultrafiltration), recrystallization, and/or solvent-solvent partitioning.

In some embodiments, the compositions and processes disclosed herein have decreased or decrease or remove one or more agent(s) that imparts or is associated with one or more organoleptic properties in the purified protein isolates. Non limiting examples of such organoleptic properties include odor (e.g., off-odor or undesirable odor) and taste (e.g., off-taste or undesirable taste). In some embodiments, the compositions and processes disclosed herein have decreased or decrease the one or more agent(s) by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material. In some embodiments, processes decreased herein can produce odorless, tasteless, or both, compositions. In some embodiments, compositions decreased herein can be odorless, tasteless, or both.

In some embodiments, described herein is a process for making a purified protein isolate from a plant material, comprising the steps of: a) providing the plant material in a solution comprising a reducing agent; b) lysing the plant material; c) separating the lysed plant material into a solid phase and a liquid phase, wherein the liquid phase contains soluble protein and chlorophyll; d) coagulating the chlorophyll in the liquid phase by heating it to a first set temperature in no more than about 30 min, then cooling it to a second set temperature in no more than about 30 min, wherein the cooling is initiated when the liquid phase reaches the first set temperature; e) contacting the liquid phase of d) with a flocculant and/or an adsorbent, and mixing for a period of time sufficient to flocculate and/or adsorb chlorophyll in the liquid phase to the adsorbent, thereby forming a flocculated mixture; f) separating the flocculated mixture of e) into a solid phase and a liquid phase; and g) filtering the liquid phase of f) to yield a filtrate containing a purified protein. In some embodiments, the plant material is harvested and cleaned before the process is started. For instance, in some embodiments, the plant material is chemically washed or washed with water prior to processing. In some embodiments, the plant material is washed more than one time prior to processing.

In some embodiments, the plant material is mixed in a solution comprising a reducing agent. Examples of reducing agents suitable for use in the disclosed processes include, but are not limited to, 2-mercaptoethanol (BME), 2-mercaptoethylamine-HCL, sodium sulfite, magnesium sulfite, sodium metabisulfite, sodium bisulfite, cysteine hydrochloride, dithiothreitol (DTT), glutathione, cysteine, tris(2-carboxyethyl)phosphine (TCEP), ferrous ion, nascent hydrogen, sodium amalgam, oxalic acid, formic acid, magnesium, manganese, phosphorous acid, potassium, sodium, and any combination thereof. Said solution may comprise other components to provide beneficial properties to the solution or to the process. Examples such components include buffering agents, chelating agents, protease inhibitors, pH adjustors, and the like.

Lysing can be through any suitable method to disrupt plant material and release cellular contents, such as a plant cell's cytoplasm. Types of lysing described herein include mechanical, chemical, and/or enzymatic lysis. Mechanical lysing encompassed by the processes described herein includes, but is not limited to, mechanical agitation, pressure, grinding, squeezing, shearing, using a blender, using a mill, using a press, a sonicator, a nitrogen burst, ultrasonic energy, by freezing, using a homogenizer, a pulse electric field, a disintegrator, more than one of the foregoing, or any combination thereof. Chemically lysing encompassed by the processes described herein includes, but is not limited to, lysed chemically using one or more of detergents (e.g., ionic, cationic, anionic, sodium dodecyl sulfates, non-ionic, zwitterionic, hypotonic, hypertonic, and isotonic detergents and the like). Chemically lysing encompassed by the processes described herein includes, but is not limited to, using one or more enzymes, such as cellulase and/or pectinase.

Separation of the lysed plant material and/or flocculated mixture into solid phase and a liquid phase may be performed by any suitable solid-liquid separation technique. Suitable solid-liquid separation techniques include but are not limited to: gravity settling, sieving (e.g., circular vibratory separator or a linear/inclined motion shaker), filtration (e.g., dead-end filtration system, using ultrafiltration, using a tangential flow filtration system, or using a plate filter), centrifugation (e.g., disk stack centrifuge, a decanter centrifuge, a continuous centrifuge, or a basket centrifuge), a press (e.g., screw press, a French press, a belt press, a filter press, a fan press, a finisher press, or a rotary press), or decanting (e.g., using a decanter), or any combination thereof.

The process for making the protein isolates described herein can also comprise a step of coagulating components that are undesired (e.g., components that are not protein, such as RuBisCO) using any suitable method to effect coagulation. Examples include, but are not limited to: heat treatment, cooling; addition of one or more salts (e.g., a calcium salt, a magnesium salt, a beryllium salt, a zinc salt, a cadmium salt, a copper salt, an iron salt, a cobalt salt, a tin salt, a strontium salt, a barium salt, a radium salt, calcium chloride, calcium nitrate, or iron carbonate potassium phosphate, calcium chloride, or any combination thereof); addition of quaternary ammonia specie; addition of a polymer based coagulate; electrocoagulation; and the like.

The process for making the protein preparation may also comprise a step of contacting the liquid phase with a flocculant and/or an adsorbent and mixing for a period of time sufficient to flocculate and/or adsorb chlorophyll in the liquid phase to the adsorbent, thereby forming a flocculated mixture. Any suitable process of flocculation can be used and exemplary flocculants may include, but are not limited to, an alkylamine epichlorohydrin, polydimethyldiallylammonium chloride, a polysaccharide (e.g., chitosan), a polyamine, starch, aluminum sulphate, alum, polyacrylamide, polyacromide, or polyethyleneimine. Any suitable adsorbent can be used and exemplary adsorbents may include activated carbon, graphite, silica gel, zeolites, clay, polyethylene, and resins (e.g, ion-exchange resins, size exclusion chromatography (SEC) resins, affinity based resins, or hydrophobicity based resin).

After the separation of the flocculated mixture into a solid phase and a liquid phase, the liquid phase may be filtered to yield a filtrate containing the purified protein. Any suitable method of filtration can be used and include, for example, the use of surface filters, depth filters, by membrane filtration, column filtration, diafiltration, ultrafiltration, tangential flow filtration, filtration with diatomaceous earth, filtration with silt, filtration with activated carbon, and the like.

Processes disclosed herein separates proteins from other compounds found in plant material. Such processes can be considered as purifying or isolating proteins described herein to obtain protein isolates as described herein. For example, the process may remove chlorophyll, volatilized chemical compounds, acids, bases, sugars, salts, and/or lipids. In some embodiments, the processes disclosed herein reduce the amount of chlorophyll, volatilized chemical compounds, acids, bases, sugars, salts, and/or lipids by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material.

In some embodiments, the processes disclosed herein remove chlorophyll from plant material, producing protein isolates that are dechlorophyllized. For instance, in some embodiments, the weight ratio of chlorophyll to protein in the protein isolate is less than about 1:1000, 1:1500, 1:2000, or 1:2500. In some embodiments, the processes disclosed herein reduce the amount of chlorophyll by 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, or 99% relative to the source plant material.

Liquid phases and/or filtrates can be further sterilized, concentrated, dialyzed, dried, and/or otherwise processed to provide protein isolates for use herein. In some embodiments, liquid phases and/or filtrates may be dried. In some embodiments, drying may be accomplished using a spray dryer, a freeze dryer, drum drying, film drying, bed drying, a flash dryer, or a rotary dryer.

In some embodiments, the purity of protein isolates described herein is at least about 30%, 40%, 50%, 60%, 70%, 80%, 90%, 95%, or more. In some embodiments, the purity of protein isolate described herein is 80% or more. In certain embodiments, protein isolates described herein may contain no more than 50%, 40%, 30%, 20% 10% or less impurities. In certain embodiments, protein isolates described herein may contain no more than 20% 10% or less impurities. In some embodiments, processes described herein produce one or more by-products, such as sodium hydroxide.

In some embodiments, the methods of plant protein production described herein comprise extracting plant protein isolate from harvest aquatic biomass. In some embodiments, plant protein isolate is RuBisCO, wheat gluten, a dehydrin protein, an albumin, a conglycinin, a globulin, a zein, a leghemoglobin, a non-symbiotic hemoglobin, or a cytoplasmic actin. Non-limiting examples of suitable plant proteins include RuBisCO, an algal protein, a seaweed protein, an albumin, a gluten, a glycinin, a conglycinin, a legumin, a globulin, a vicilin, a conalbumin, a gliadin, a glutelin, a glutenin, a hordein, a prolamin, a phaseolin, a proteinoplast, a secalin, a triticeae gluten, a zein, an oleosin, a caloleosin, a steroleosin, or mixtures thereof (e.g., albumin fractions). In some embodiments, plant protein isolate is RuBisCO.

In some embodiments, plant protein isolate described herein can be used to formulate compositions for use herein. In some embodiments, RuBisCO used in compositions disclosed herein is isolated from one or more sources described herein. Accordingly, RuBisCO protein isolate used in compositions disclosed herein is obtained from any chlorophyll-containing plant material. In some embodiments, RuBisCO protein isolate used in the disclosed compositions is isolated from a member of the Amaranthaceae, Araceae, Poaceae, Solanaceae, or Apiaceae family. In some embodiments, RuBisCO protein isolate used in the disclosed compositions is isolated from a member of the Lemna, Spirodela, Wolffia, Wolffiella, Spinacia, Beta, Leymus, Nicotiana, Zea, Solanum, Daucus, Atriplex, Nannochloropsis, Chlorella, Dunaliella, Scenedesmus, Selenastrum, Oscillatoria, Phormidium, Spirulina, Amphora, or Ochromona genus. In some embodiments, RuBisCO protein isolate used in the disclosed compositions can be isolated from one or more of the following species: Lemna aequinoctialis, Lemna disperma, Lemna ecuadoriensis, Lemna gibba (swollen duckweed), Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Leymus arenarius, Zea mays, Daucus carota, Solanum tuberosum, Atriplex lentiformis, Scendesmus dimorphus, Pereskia aculeata, Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., Isochrysis aff. galbana, Isochrysis galbana, Lepocinclis, Micractinium, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrine, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana. In some embodiments, RuBisCO used in compositions disclosed herein is isolated from one or more sources described herein. In some embodiments, RuBisCO proteins are extracted from an aquatic surface-dwelling plant. In some embodiments, RuBisCO proteins are extracted from Lemna minor. Lemna minor is a floating freshwater aquatic plant, with one, two, three, or four leaves, each having a single root hanging in the water. Lemna minor has a subcosmopolitan distribution and is native throughout most of Africa, Asia, Europe and North America. It is present wherever freshwater ponds and slow-moving streams occur, except for arctic and subarctic climates.

In some embodiments, a RuBisCO protein isolate is free from other substances, including naturally occurring substances, such as chlorophyll, and/or substances added to isolate RuBisCO protein from a RuBisCO source, such as a solvent or water. In some embodiments, RuBisCO protein isolate is chlorophyll-free. In some embodiments, RuBisCO is also flavorless, tasteless, colorless, and/or uncolored.

Subsequent extraction, RuBisCO proteins may be further processed to improve the purity of the protein sample. In other scenarios, the extracted RuBisCO may undergo further processing (e.g., adjusting the pH, adjusting the heat, etc.) in order to concentrate the extracted proteins.

Additionally, extracted RuBisCO proteins may also be combined with other proteins, where such combination may occur before or after the additional processing described. In some embodiments, RuBisCO protein isolate comprises other proteins, including but not limited to: pea proteins, isolates, and/or concentrates; garbanzo (chickpea) proteins, isolates, and/or concentrates; fava bean proteins, isolates, and/or concentrates; soy proteins, isolates, and/or concentrates; rice proteins, isolates, and/or concentrate; potato proteins, isolates, and/or concentrates; hemp proteins, isolates, and/or concentrates; canola proteins, isolates, and/or concentrates; wheat proteins, isolates, and/or concentrates; corn proteins, isolates, and/or concentrates; zein proteins, isolates, and/or concentrates; rice proteins, isolates, and/or concentrates; oat proteins, isolates, and/or concentrates; potatoes proteins, isolates, and/or concentrates; peanut proteins, isolates, and/or concentrates; legumes/pulses proteins, isolates, and/or concentrates; lentils proteins, isolates, and/or concentrates; or any combinations thereof. RuBisCO protein and other protein combinations. In some examples, RuBisCO and additional proteins may be in a dry form (e.g., powdered, pelletized, or the like). In other examples, the RuBisCO and the additional proteins may be in a liquid form or in a liquid solution. In some embodiments, a RuBisCO protein isolate from one source, may be combined with a RuBisCO protein isolate from separate source. For example, RuBisCO protein isolate may be extracted from an aquatic biomass (e.g., Lemna minor) and combined with RuBisCO extracted from a second source (e.g., Chlorella vulgaris).

In some embodiments, the RuBisCO protein isolate comprises protein comprising a sequence that has at least about 60%, 65%, 70%, 75%, 80%, 85%, 90%, 95%, 99%, or about 100% sequence identity with any one of the sequences as set forth in TABLE 1. In some embodiments, the RuBisCO protein isolate comprises protein comprising a sequence that has at least about 60%, 65%, 70%, 75%, 80%, 85%, 90%, 95%, 99%, or about 100% sequence identity with more than one of the sequences as set forth in TABLE 1. In some embodiments, the RuBisCO protein isolate comprises one or more protein comprising one or more sequences, each of which has at least about 60%, 65%, 70%, 75%, 80%, 85%, 90%, 95%, 99%, or about 100% sequence identity with any one of the sequences as set forth in SEQ ID NOs: 1 to 10. Provided in TABLE 1 are large and small RuBisCO subunits for various species described herein, including Lemna minor, Nicotiana tabacum, Medicago sativa (alfalfa), Spinacia oleracea (Spinach), and Chlorella vulgaris (green algae).

TABLE 1
RUBISCO SEQUENCES

| SEQ ID NO: | Sequence |
|---|---|
| 1 | MSPQTETKASAGFKAGVKDYKLNYYTPEYETKDTDILAAFRVTPQPGVPPEE |
| | AGAAVAAESSTGTWTTVWTDGLTSLDRYKGRCYHIEPVAGEENQFIAYIAYP |
| | LDLFEEGSVTNMFTSIVGNVFGFKALRALRLEDLRIPPAYSKTFQGPPHGIQVE |
| | RDKLNKYGRPLLGCTIKPKLGLSAKNYGRAVYECLRGGLDFTKDDENVNSQP |
| | FMRWRDRFLFCAEAIYKAQAETGEIKGHYLNATAGTCEEMIKRAVFARELGV |
| | PIVMHDYLTGGFTANTSLAYYCRDNGLLLHIHRAMHAVIDRQKNHGMHFRV |
| | LAKALRMSGGDHVHSGTVVGKLEGEREMTLGFVDLLRDDFIEKDRSRGIFFT |
| | QDWVSMPGVLPVASGGIHVWHMPALTEIFGDDSVLQFGGGTLGHPWGNAPG |
| | AVANRVALEACVKARNEGRDLAREGNEIIREACNWSPELAAACEVWKEIKF |
| | EYEPVDKLDVK |
| 2 | MASSMMASTAAAVARAGPAQSSMVPFNACRSSVPFPATRKANNNLSTLPGN |
| | GGRVSCMQVWPPEGLKKFETLSYLPPLSVEDLAKEVDYLLRNDWVPCIEFSK |
| | EGFVYRENHASPGYYDGRYWTMWKLPMFGCTDASQVIAEVEEAKKAYPEY |
| | FVRIIGFDNKRQVQCISFIAYKPT |
| 3 | MSPQTETKASVGFKAGVKEYKLTYYTPEYQTKDTDILAAFRVTPQPGVPPEE |
| | AGAAVAAESSTGTWTTVWTDGLTSLDRYKGRCYRIERVVGEKDQYIAYVAY |
| | PLDLFEEGSVTNMFTSIVGNVFGFKALRALRLEDLRIPPAYVKTFQGPPHGIQV |
| | ERDKLNKYGRPLLGCTIKPKLGLSAKNYGRAVYECLRGGLDFTKDDENVNS |
| | QPFMRWRDRFLFCAEALYKAQAETGEIKGHYLNATAGTCEEMIKRAVFARE |
| | LGVPIVMHDYLTGGFTANTSLAHYCRDNGLLLHIHRAMHAVIDRQKNHGIHF |
| | RVLAKALRMSGGDHIHSGTVVGKLEGERDITLGFVDLLRDDFVEQDRSRGIY |
| | FTQDWVSLPGVLPVASGGIHVWHMPALTEIFGDDSVLQFGGGTLGHPWGNA |
| | PGAVANRVALEACVKARNEGRDLAQEGNEIIREACKWSPELAAACEVWKEI |
| | VFNFAAVDVLDK |
| 4 | MAFLIMSSAAAVATGTNAAQASMIAPFTGLKSATSFPVSRKQNLDITSIASNG |
| | GRVQCMQVWPPINKKKYETLSYLPDLSEEQLLREVEYLLKNGWVPCLEFETE |
| | HGFVYRENNKSPGYYDGRYWTMWKLPMFGCTDATQVLAEVEEAKKAYPQ |
| | AWIRIIGFDNVRQVQCISFIAYKPEGY |
| 5 | MSPQTETKATVGFKAGVKDYRLTYYTPDYETKDTDILAAFRVSPQPGVPAEE |
| | AGAAVAAESSTGTWTTVWTDGLTSLDRYKGRCYHIEPVAGEETQFIAYVAYP |
| | LDLFEEGSVNYMFTSIVGNVFGFKALRALRLEDLRIPAAYVKTFQGPPQGIQV |
| | ERDKLNKYGRPLLGCTIKPKLGLSAKNYGRAVYECLRGGLDFTKDDENVNS |
| | QPFMRWRDRFLFCAEAIYKAQAETGEIKGHYLNATAGTCEEMMKRAVFARE |
| | LGVPIVMHDYLTVGFTANTTLAHYCRDNGLLLHIHRAMHAVIDRQKNHGMH |
| | FRVLAKALRMSGGDHIHAGTVVGKLEGERDITLGFVDLLRDDFIEKDRSRGIF |
| | FTQDWVSLPGVLPVASGGIHVWHMPALTEIFGDDSVLQFGGGTLGHPWGNA |
| | PGAVANRVALEACVQARNEGRDLAREGNEIIREATKWSPELAAACEVWKEIK |
| | FEFPAMDN |
| 6 | MALISSAAVTTVNRASSAQANLVAPFTGLKSSAGFPVTKKTNNDITSIASNGG |
| | RVNCMQVWPPVGKKKFETLSYLPPLTEEQLAKEVEYLIRKGWIPCLEFELEK |
| | GFVYRENHRSPGYYDGRYWTMWRLPLFGATDSSQVLKELADCKAEYPDSFI |
| | RIIGFDNVRQVQCISFIAHTPKNY |
| 7 | MSPQTETKASVEFKAGVKDYKLTYYTPEYETLDTDILAAFRVSPQPGVPPEEA |
| | GAAVAAESSTGTWTTVWTDGLTNLDRYKGRCYHIEPVAGEENQYICYVAYP |
| | LDLFEEGSVTNMFTSIVGNVFGFKALRALRLEDLRIPVAYVKTFQGPPHGIQV |
| | ERDKLNKYGRPLLGCTIKPKLGLSAKNYGRAVYECLRGGLDFTKDDENVNS |
| | QPFMRWRDRFLFCAEALYKAQAETGEIKGHYLNATAGTCEDMMKRAVFAR |
| | ELGVPIVMHDYLTGGFTANTTLSHYCRDNGLLLHIHRAMHAVIDRQKNHGM |
| | HFRVLAKALRLSGGDHIHSGTVVGKLEGERDITLGFVDLLRDDYTEKDRSRGI |
| | YFTQSWVSTPGVLPVASGGIHVWHMPALTEIFGDDSVLQFGGGTLGHPWGN |
| | APGAVANRVALEACVQARNEGRDLAREGNTIIREATKWSPELAAACEVWKEI |
| | KFEFPAMDTV |
| 8 | MQVWPPLGLKKFETLSYLPPLTTEQLLAEVNYLLVKGWIPPLEFEVKDGFVY |
| | REHDKSPGYYDGRYWTMWKLPMFGGTDPAQVVNEVEEVKKAPPDAFVRFI |
| | GFNDKREVQCISFIAYKPAGY |
| 9 | MSPQTETKARVGFKAGVKDYRLTYYTPDYQPKDTDILAAFRMTPQPGVPPEE |
| | AGAAVAAESSTGTWTTVWTDGLTSLDRYKGRCYDIEPVPGEENQYIAYIAYP |
| | LDLFEEGSVTNLFTSIVGNVFGFKALRALRLEDLRIPPAYVKTFQGPPHGIQVE |
| | RDKLNKYGRGLLGCTIKPKLGLSAKNYGRAVYECLRGGLDFTKDDENVNSQ |
| | PFMRWRDRFLFVAEAIYKSQAETGEIKGHYLNATAATAEAMMQRAECAKDL |
| | GVPIIMHDYLTGGFTANTSLSHYCRDNGLLLHIHRAMHAVIDRQRNHGITFRV |
| | LAKALRLSGGDHLHSGTVVGKLEGEREVTLGFVDLMRDDYIEKDRSRGIYFT |
| | QDWVSLPGTMPVASGGIHVWHMPALVEIFGDDACLQFGGGTLGHPWGNAP |
| | GAAANRVALEACTQARNEGRDLAREGGDVIRAACKWSPELAAACEVWKEIK |
| | FEFETIDTL |
| 10 | MAALTASLVSCPVAVAAKPARLASPAWPASLSPRRLSPPSPRGPSQTAAAPAR |
| | CSCGSPLTTSSSRPSPTCPSDRRPDRQAGRLHHPSGWTPALEFSNAESAYVKD |
| | VANIRFTGGSASCNYYDNRYWAMYKLPMFGCTDASQVLAEIANAVKTFPDS |
| | YVRMAAFDAVRQVQTVAILVHRPASATDYRLPENPQPLIGCTTQLERPQYCK |
| | SLANL |

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to SEQ ID NO: 1 or 2 or both.

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to SEQ ID NO: 3 or 4 or both.

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to SEQ ID NO: 5 or 6 or both.

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to SEQ ID NO: 7 or 8 or both.

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to SEQ ID NO: 9 or 10 or both.

RuBisCO is composed of 8 large subunits with a molecular mass of about 53 kDalton and 8 small subunits with a molecular mass of about 12 kDalton. Accordingly, in some embodiments, a disclosed RuBisCO protein isolate comprises one or more large subunits, one or more small subunits, or any combination thereof. For example, a RuBisCO protein isolate includes a large subunit, a small subunit or both. In some embodiments, a RuBisCO subunit comprises an amino acid sequence in any one of the Uniprot records set forth in TABLE 2.

In some embodiments, a RuBisCO protein isolate comprises protein comprising sequence that has at least 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% sequence identity to an amino acid sequence as set forth in any one of the records described in TABLE 2.

TABLE 2
RUBISCO SUBUNITS

| Subunit | Uniprot Accession Number |
|---|---|
| Large | A9L9A4, A0A3GlN0S3, K4Fl51, A0A3GlMVZ6, H9ALP2, |
| | D6NJG9, Q8WHI2, G8D4W8, D3W4G8, H9ALP3, GOWYT7, |
| | B5WX54, A0A1S7JIB4, A0A482K3Y6, R9S086, A0A411PP11, |
| | D6NJG2, H9AHZ6, Q8WHI1, R4I7N5, 085040, Q31NB3, |
| | P00880, P00875, P00879, O93627, O03042, P0C2C2, P04718, |
| | P00877, P0C512, P04717, P00876, Pll383, P22849, Q8DIS5, |
| | P22859, 085040, B0Z5Bl, Q31HD8, P22850, |
| Small | P19309, P19308, P19310, P19311, Pl9312, P00872, P10795, |
| | B3H5S2, P10796, P10797, A0A0S4IJL0, P45686, P04716, |
| | P69249, Q0INY7, Q31NB2, P05348, P08475, P00873, |

In some embodiments, a disclosed RuBisCO protein isolate comprises protein comprising about 4 to about 478 contiguous amino acids, but is less than the full-length, native or naturally occurring, wild-type ribulose-1,5-bisphosphate carboxylase/oxygenase polypeptide. In some embodiments, a disclosed RuBisCO protein isolate comprises protein comprising about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, about 101, about 102, about 103, about 104, about 105, about 106, about 107, about 108, about 109, about 110, about 111, about 112, about 113, about 114, about 115, about 116, about 117, about 118, about 119, about 120, about 121, about 122, about 123, about 124, about 125, about 126, about 127, about 128, about 129, about 130, about 131, about 132, about 133, about 134, about 135, about 136, about 137, about 138, about 139, about 140, about 141, about 142, about 143, about 144, about 145, about 146, about 147, about 148, about 149, about 150, about 151, about 152, about 153, about 154, about 155, about 156, about 157, about 158, about 159, about 160, about 161, about 162, about 163, about 164, about 165, about 166, about 167, about 168, about 169, about 170, about 171, about 172, about 173, about 174, about 175, about 176, about 177, about 178, about 179, about 180, about 181, about 182, about 183, about 184, about 185, about 186, about 187, about 188, about 189, about 190, about 191, about 192, about 193, about 194, about 195, about 196, about 197, about 198, about 199, about 200, about 201, about 202, about 203, about 204, about 205, about 206, about 207, about 208, about 209, about 210, about 211, about 212, about 213, about 214, about 215, about 216, about 217, about 218, about 219, about 220, about 221, about 222, about 223, about 224, about 225, about 226, about 227, about 228, about 229, about 230, about 231, about 232, about 233, about 234, about 235, about 236, about 237, about 238, about 239, about 240, about 241, about 242, about 243, about 244, about 245, about 246, about 247, about 248, about 249, about 250, about 251, about 252, about 253, about 254, about 255, about 256, about 257, about 258, about 259, about 260, about 261, about 262, about 263, about 264, about 265, about 266, about 267, about 268, about 269, about 270, about 271, about 272, about 273, about 274, about 275, about 276, about 277, about 278, about 279, about 280, about 281, about 282, about 283, about 284, about 285, about 286, about 287, about 288, about 289, about 290, about 291, about 292, about 293, about 294, about 295, about 296, about 297, about 298, about 299, about 300, about 301, about 302, about 303, about 304, about 305, about 306, about 307, about 308, about 309, about 310, about 311, about 312, about 313, about 314, about 315, about 316, about 317, about 318, about 319, about 320, about 321, about 322, about 323, about 324, about 325, about 326, about 327, about 328, about 329, about 330, about 331, about 332, about 333, about 334, about 335, about 336, about 337, about 338, about 339, about 340, about 341, about 342, about 343, about 344, about 345, about 346, about 347, about 348, about 349, about 350, about 351, about 352, about 353, about 354, about 355, about 356, about 357, about 358, about 359, about 360, about 361, about 362, about 363, about 364, about 365, about 366, about 367, about 368, about 369, about 370, about 371, about 372, about 373, about 374, about 375, about 376, about 377, about 378, about 379, about 380, about 381, about 382, about 383, about 384, about 385, about 386, about 387, about 388, about 389, about 390, about 391, about 392, about 393, about 394, about 395, about 396, about 397, about 398, about 399, about 400, about 401, about 402, about 403, about 404, about 405, about 406, about 407, about 408, about 409, about 410, about 411, about 412, about 413, about 414, about 415, about 416, about 417, about 418, about 419, about 420, about 421, about 422, about 423, about 424, about 425, about 426, about 427, about 428, about 429, about 430, about 431, about 432, about 433, about 434, about 435, about 436, about 437, about 438, about 439, about 440, about 441, about 442, about 443, about 444, about 445, about 446, about 447, about 448, about 449, about 450, about 451, about 452, about 453, about 454, about 455, about 456, about 457, about 458, about 459, about 460, about 461, about 462, about 463, about 464, about 465, about 466, about 467, about 468, about 469, about 470, about 471, about 472, about 473, about 474, about 475, about 476, about 477, or about 478 contiguous amino acids of SEQ ID NO: 1, 2, both, one or more large subunits set forth in TABLE 2, one or more small subunits set forth in TABLE 2, or any combination thereof, but is less than the full-length, native or naturally occurring, wild-type ribulose-1,5-bisphosphate carboxylase/oxygenase polypeptide. In some embodiments, the RuBisCO protein isolate comprises a full length protein of RuBisCO subunit 1 and or subunit 2.

In some embodiments, compositions disclosed herein comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% protein isolate by dry weight or total weight. In some embodiments, the compositions comprise about 5% to about 80%, about 6% to about 50%, about 7% to about 40%, about 8% to about 30%, about 9% to about 20%, or about 10% to about 15% protein isolate by dry weight or total weight. In certain embodiments, total weight includes a preservative solution. In some embodiments, description of a measurement by weight is understood to encompass dry weight or total weight.

In some embodiments, compositions disclosed herein comprise about 1 g to about 100 g of protein isolate. In some embodiments, compositions disclosed herein comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, or more of a protein isolate, such as a RuBisCO protein isolate.

Compositions described herein can further comprise a plasticizer, an aqueous solution, an acid, a base, a soluble salt, a leavening agent, an additive, optionally a food additive, or any combination thereof. Additives can be synthetic, plant-based, animal-based, or any combination thereof. Examples of food additives described herein include a flavoring component, coloring component, starch, or fiber.

In some embodiments, compositions described herein further comprise one or more of a(n): plasticizer, aqueous solution, acid, base, salt, leavening agent, amino acid, nutrient, flavoring component, a surfactant, an emulsifier, coloring component, starch, fiber, lecithin, cross-linking agent, lipid, flour, other additives (e.g., a food additive), or any combination thereof.

### Plasticizers

In some examples, the protein isolates, such as RuBisCO protein isolates, may be combined with a plasticizer. As described herein, plasticizers are low molecular weight, non-volatile compounds used as additives or incorporated into other material in order to increase flexibility and dispensability. The process of plasticizing a protein-based polymer or fiber may be affected by the selected plasticizer's molecular weight, as well as the number and position of various hydroxyl groups. Examples of plasticizers include: water, an aqueous polysaccharide solutions, an alcohol, a polyalcohol, a glycerol (glycerine), a gum Arabic, a xanthan gum, a locust bean gum, and/or an aqueous solution of carbohydrates, among others.

Accordingly, in some embodiments, compositions disclosed herein further comprise a plasticizer. In some embodiments, a plasticizer comprises one or more gums. The term “gum” as used herein can refer to materials that act as gelling agents, and can comprise, for example, polysaccharides and/or glycoproteins. Gums used in compositions herein include: xanthan gum, acacia gum, gellan gum, guar gum, locust bean gum, tragacanth gum, carrageenan gum, or a combination thereof.

An amount of the plasticizer added may vary between about 0.01% to about 10% by weight depending on the amount of the protein. In some embodiments, compositions disclosed herein comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3% or more plasticizer by weight. In some embodiments, compositions disclosed herein comprise about 0.1 g, about 0.2 g, about 0.3 g, about 0.4 g, about 0.5 g, about 0.6 g, about 0.7 g, about 0.8 g, about 0.9 g, about 1 g or more of a plasticizer.

Depending on the plasticizer used, the moisture content of the protein isolate compositions may require adjustment. In some embodiments the moisture content may range from about 15% to about 30%. The protein isolate, and optionally, any additional protein(s), in combination with the plasticizer, may be exposed to heat and thermally plasticized. The plasticizing process may require mechanical mixing, which may include any means known in the art.

### Aqueous Solution

Compositions disclosed herein can further comprise an aqueous solution. Compositions herein can comprise about 1 wt % to about 100 wt % by weight of an aqueous solution. In some embodiments, an aqueous solution can comprise water, alcohol, acids, such as citric acid and/or ascorbic acid, or another liquid substance. In some embodiments, the liquid comprise glycerol (glycerine). In certain embodiments, an aqueous solution can comprise a preservative, and may be referred to herein as a preservative solution. Such a preservative solution can comprise water, and one or more acids. Preservative aqueous solutions can be about

Compositions herein can comprise about 1%, about 10%, about 20%, about 30%, about 40%, about 50%, about 60%, about 70%, about 80%, about 90%, about 95%, about 96%, about 97%, about 98%, about 99%, or about 100% by weight of aqueous solution. Compositions herein can comprise about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g or more of an aqueous solution.

In some embodiments, an aqueous solution can comprise water, an acid, a base, solutes, soluble salts, or combinations thereof. In some embodiments, solutes can include polysaccharides, such as dissolved polysaccharide to make an aqueous polysaccharide solution.

### Oils

Compositions disclosed herein can further comprise an oil. Compositions herein can comprise about 1 wt % to about 100 wt % by weight of an oil. In some embodiments, an oil can comprise another liquid substance. In some embodiments, an oil can solubilize a solid substance. In some embodiments, an oil can solubilize RuBisCO. In some embodiments, an oil can solubilize a RuBisCO protein isolate. In certain embodiments, an oil can comprise a preservative, and may be referred to herein as a preservative. Such a preservative solution can comprise an oil, and one or more acids.

Compositions herein can comprise about 1%, about 10%, about 20%, about 30%, about 40%, about 50%, about 60%, about 70%, about 80%, about 90%, about 95%, about 96%, about 97%, about 98%, about 99%, or about 100% by weight of an oil. Compositions herein can comprise about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g or more of an oil.

In some embodiments, an oil can comprise an acid, a base, solutes, soluble salts, or combinations thereof. In some embodiments, solutes can include an acid, a base, solutes, soluble salts, or combinations thereof. In some embodiments, solutes can include polysaccharides, such as dissolved polysaccharide to make an oil comprising a polysaccharide in an oil phase.

In some embodiments, the liquid phases and/or filtrates for use in the disclosed processes may an oil. In some embodiments, the oil is a mineral oil, a vegetable oil, a white oil, or any oil that is insoluble in a foaming medium except silicone oil. In some embodiments, an oil further contains a wax and/or hydrophobic silica. In some embodiments, waxes are selected from ethylene bis-stearamide (EBS), paraffin waxes, ester waxes, and fatty alcohol waxes. In some embodiments the oil is a mineral oil, a coconut oil, a vegetable oils, long-chain fatty alcohol, and fatty acid soaps or esters. In some embodiments, an oil described herein is a component in an oil- or water-based emulsion. In some embodiments, the oil is part of an oil in water emulsion. In some embodiments the oil is part of a water in oil emulsion. In some embodiments, the emulsion further comprises a polyethylene glycol and/or polypropylene glycol copolymers.

### Acids/Bases/Soluble Salts

In some embodiments, compositions herein can comprise one or more salts, including soluble salts. Examples of soluble salts include, but are not limited to, calcium lactate gluconate. Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7% or more by weight of salts, including soluble salts, such as calcium lactate gluconate. Compositions herein can comprise about 0.1 g, about 0.2 g, about 0.3 g, about 0.4 g, about 0.5 g, about 0.6 g, about 0.7 g, about 0.8 g, about 0.9 g, about 1 g, about 2 g, about 3 g, about 4 g, about 5 g, about 6 g, about 7 g, about 8 g, about 9 g, about 10 g or more of a salt, including soluble salt.

In some embodiments, compositions herein can comprise one or more acids or salts thereof. Examples of acids include, but are not limited to, citric acid and ascorbic acid. Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1% or more weight of an acid, such as citric acid and/or ascorbic acid. Compositions herein can comprise about 0.1 g, about 0.2 g, about 0.3 g, about 0.4 g, about 0.5 g, about 0.6 g, about 0.7 g, about 0.8 g, about 0.9 g, about 1 g, or more of an acid, such as citric acid and/or ascorbic acid.

In some embodiments, compositions herein can comprise one or more bases thereof. Examples of bases include, but are not limited to, potassium carbonate, calcium carbonate, or sodium hydroxide. Compositions herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, or about 1% or more by weight of a base. Compositions herein can comprise about 0.1 g, about 0.2 g, about 0.3 g, about 0.4 g, about 0.5 g, about 0.6 g, about 0.7 g, about 0.8 g, about 0.9 g, about 1 g, or more of a base.

The one or more acids and/or bases, and/or salts can be utilized to modify the pH of the composition, such as the aqueous solution of the composition.

In some embodiments, compositions disclosed herein can have a pH that is similar to the pH of natural eggs or dairy. Natural eggs can have a pH range of about 6-8. Dairy can have a pH range of about 4 to about 8.5. Compositions described herein can have a pH of about 4, about 4.1, about 4.2, about 4.3, about 4.4, about 4.5, about 4.6, about 4.7, about 4.8, about 4.9, about 5, about 5.1, about 5.2, about 5.3, about 5.4, about 5.5, about 5.6, about 5.7, about 5.8, about 5.9, about 6, about 6.1, about 6.2, about 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, about 8.3, about 8.4, or about 8.5. In some embodiments, compositions described herein can have a pH of less than 4.0. In some embodiments, compositions described herein can have a pH of greater than 8.5. In some embodiments, the pH of compositions can be described herein be about 4 to about 8.5, about 5 to about 7.8, or about 6.4 to about 6.9.

### Amino Acids

In some embodiments, compositions described herein can further include one or more amino acids. Compositions disclosed herein can include one or more amino acids comprising: alanine, arginine, asparagine, aspartate, cysteine, cystine, histidine, selenocysteine, methionine, isoleucine, leucine, lysine, phenylalanine, threonine, tryptophan, 5-hydroxytryptophan, valine, glutamate, glutamine, glycine, praline, serine, tyrosine. In some embodiments, compositions described herein can comprise one or more amino acids found in a natural egg and/or dairy. Examples of amino acids found in a natural egg include histidine, isoleucine, leucine, lysine, methionine, phenylalanine, threonine, tryptophan and valine. Examples of amino acids found in dairy include leucine, isoleucine, glutamine, phenylalanine, proline and lysine. Compositions described herein can comprise one or more amino acids in an amount that is similar to the amount found in a comparable sample unit (e.g., as determined by the Atwater system) of dairy, an egg or a portion thereof, such as egg white/albumin, or egg yolk.

### Nutrients

Compositions described herein can comprise one or more nutrients. In some embodiments, compositions described herein can comprise one or more nutrients found in natural eggs and/or dairy. Nutrients found in natural eggs include Vitamin D, Vitamin B12, Choline, Iron, Lutein, Zeaxanthin, Riboflavin (Vitamin B2), Pantothenic Acid (Vitamin B5), Vitamin A, Vitamin E, Phosphorus, Folate, Iodine, and Selenium. Nutrients found in dairy include, calcium, phosphorus, vitamin A, vitamin D (fortified), riboflavin, vitamin B12, protein, potassium, zinc, choline, magnesium, and selenium. Compositions described herein can include one or more nutrients comprising: thiamine, ascorbic acid, L-theanine, acetyl glutathione, riboflavin, pantothenic acid, folic acid, cobalin, Vitamin D, Vitamin B12, Choline, Iron, Lutein, Zeaxanthin, Vitamin A, Vitamin E, Phosphorus, Folate, Iodine, Selenium, zinc, potassium, calcium, or magnesium. In some embodiments, compositions described herein can comprise one or more nutrients in an amount found in a comparable unit (e.g., as determined by the Atwater system) of dairy, an egg or a portion thereof, such as egg white/albumin, or egg yolk. In some embodiments, the compositions can be fortified with nutrients to provide a comparable or improved nutrient profile comparable to a natural egg and/or dairy.

### Flavoring Components

Compositions described herein can comprise one or more flavoring components. In some embodiments, compositions can comprise one or more natural flavoring components or artificial flavoring components, such as salt, spices, such as turmeric, salt, cinnamon, cloves, allspice, ginger, vanilla, vanilla extract, vanilla flavoring, a sugar (e.g., granulated or powdered sugar), tartar, sweeteners, monosodium glutamate, chocolate chips, coco powder, nuts (e.g., pecans) sulfuric flavoring components, such as black salt, or other flavoring components, such as a flavor masker. In some embodiments, a sugar can be glucose, ribose, maltodextrin, xylose, arabinose, fructose, mannose, galactose, maltose, lactose, a stereoisomer thereof, or combinations thereof. In some embodiments, an artificial flavoring component can be a Givaudan Masker. Compositions disclosed herein can comprise about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of a flavoring component. about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g, about 310 g, about 320 g, about 330 g, about 340 g, about 350 g, about 360 g, about 370 g, about 380 g, about 390 g, about 400 g or more of a flavoring component.

### Coloring Components

Compositions described herein can comprise one or more coloring components. In some embodiments, the compositions can comprise one or more coloring agents. In some embodiments, compositions can comprise one or more natural coloring components or artificial coloring components. In some embodiments, coloring components included in compositions described herein comprise: carotenoids such as beta-carotene, turmeric, annatto, mango yellow, palm-based oils, or combinations thereof. In some embodiments, compositions described herein can comprise about 0.01%, about 0.02%, about 0.03%, about 0.04%, about 0.05%, about 0.06%, about 0.07%, about 0.08%, about 0.09%, about 0.1% or more by weight of a coloring component. In some embodiments, compositions described herein can comprise about 0.01 g, about 0.02 g, about 0.03 g, about 0.04 g, about 0.05 g, about 0.06 g, about 0.07 g, about 0.08 g, about 0.09 g, about 0.1 g, or more of a coloring component.

### Starch

Compositions described herein can further comprise one or more starches, such as, for example, arrowroot starch, cornstarch, tapioca starch, mung bean starch, potato starch, sweet potato starch, rice starch, sago starch, wheat starch. The term “starch” can refer to polysaccharide materials, which when produced in plants, can act as energy stores. Starches can be used to impart thickening and stabilizing properties. In some embodiments, compositions described herein can include about 1%, about 2%, about 3%, about 4%, about 5%, about 6%, about 7%, about 8%, about 9%, about 10%, or more by weight of starch, for example, tapioca starch. In some embodiments, compositions described herein can include about 0.5-20%, about 1-15%, or about 2-10% by weight of starch, for example, tapioca starch. Compositions described herein can include about 1 g, about 2 g, about 3 g, about 4 g, about 5 g, about 6 g, about 7 g, about 8 g, about 9 g, about 10 g or more of a starch. In some embodiments the polysaccharide is naturally occurring. In some embodiments, the polysaccharide is added from an external source. In some embodiments, the polysaccharide is a component in an emulsion. In some embodiments, the emulsion is an oil in water emulsion. In some embodiments, the emulsion is a water in oil emulsion. In some embodiments the polysaccharide is konjac xanthan gum. In some embodiments the polysaccharide is curdlan. In some embodiments the polysaccharide is an agar. In some embodiments the polysaccharide is pectin. In some embodiments the polysaccharide is Kappa Carrageenan. In some embodiments, the polysaccharide described herein is dissolved in an aqueous solution. In some embodiments, the polysaccharide dissolved in an aqueous solution is part of an emulsion described herein. In some embodiments the emulsion is an oil in water emulsion. In some embodiments, the emulsion is a water in oil emulsion. In some embodiments the aqueous solution comprising a polysaccharide described herein is combined with an oil. In some embodiments, the oil is part of an oil phase further comprising RuBisCO protein isolate. In some embodiments the oil phase described herein further comprises lecithin.

### Fiber

Compositions described herein can further include fiber. In some embodiments, compositions described herein can include bran, such as a wheat bran, oat bran, corn bran, rice bran, or other bran, psyllium fiber, citrus fiber, bamboo fiber, carrot fiber, oat fiber, cellulose, methylcellulose, crystalline cellulose, pectin, or any combination thereof. In some embodiments, fiber used in composition herein, can be micronized into a fine powder. Compositions described herein can comprise about 0.1%, about 0.2%, about 0.3%, about 0.4%, about 0.5%, about 0.6%, about 0.7%, about 0.8%, about 0.9%, about 1%, about 2%, about 3% or more by weight of fiber. Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 2 g, about 3 g or more of fiber.

### Lecithin

In some embodiments, compositions described herein can comprise a surfactant. In some embodiments, the surfactant comprises at least one glycerophospholipid. In some embodiments, the at least one glycerophospholipid comprises phosphatidylcholine, phosphatidylethanolamine, phosphatidylinositol, phosphatidylserine, or phosphatidic acid. In some embodiments, the at least one glycerophospholipid comprises phosphatidylcholine, phosphatidylethanolamine, phosphatidylinositol, phosphatidylserine, and phosphatidic acid. Compositions described herein can further include lecithin. In some embodiments, the surfactant comprises at least one lecithin. Lecithins can be yellow, brownish, fatty substances that are found in animal and plant tissues, and animal product tissues, such as egg yolk. Lecithin can act as an emulsifier, and can have a similar fat profile to that of natural eggs. Lecithins can also be non-allergenic. In some embodiments, compositions described herein can comprise lecithin, such as plant-based lecithin. Examples of lecithins included in compositions disclosed herein include garbanzo lecithin, fava bean lecithin, soy lecithin, sunflower lecithin, canola lecithin, or a combination thereof. In some embodiments, compositions described herein can comprise about 0.01%, about 0.02%, about 0.03%, about 0.04%, about 0.05%, about 0.06%, about 0.07%, about 0.08%, about 0.09%, about 0.1%, about 0.2%, 0.25%, about 0.3%, about 0.4%, about 0.5%, about 0.6%, about 0.7%, about 0.8%, about 0.9%, about 1.0%, or more by weight of lectin. In some embodiments, compositions described herein can comprise about 0.01 g, about 0.02 g, about 0.03 g, about 0.04 g, about 0.05 g, about 0.06 g, about 0.07 g, about 0.08 g, about 0.09 g, about 0.1 g, about 0.2 g, about 0.3 g, about 0.4 g, about 0.5 g, about 0.6 g, about 0.7 g, about 0.8 g, about 0.9 g, about 1.0 g, about 1.5 g, about 2.0 g, 2.5 g, about 3.0 g, about 3.5 g, about 4.0 g, 4.5 g, about 5.0 g, about 5.5 g, about 6.0 g, 6.5 g, about 7.0 g, about 7.5 g, about 8.0 g, 8.5 g, about 9.0 g, about 9.5 g, about 10.0 g, or more of a lectin. In some embodiments, emulsions described herein comprise lecithin in an amount of up to about 0.25% by weight. In some embodiments, emulsions described herein comprise lecithin in an amount of up to about 0.5% by weight. In some embodiments, emulsions described herein comprise lecithin in an amount of up to about 1% by weight. In some embodiments, emulsions described herein comprise lecithin in an amount of up to about 1.25% by weight. In some embodiments, emulsions described herein comprise lecithin in an amount of up to about 1.5% by weight. In some embodiments, emulsions described herein comprise lecithin in an amount of up to about 2.0% by weight.

In some embodiments are emulsions comprising RuBisCO protein isolate and lecithin. In some embodiments the emulsions described herein comprising lecithin are water-in-oil emulsions. In some embodiments the emulsions described herein comprising lecithin are water-in-oil emulsions. In some embodiments, the lecithin is in the aqueous, or water phase, of the emulsion. In some embodiments, the lecithin is in the oil phase of the emulsion. In some embodiments, the emulsion comprises unfiltered lecithin. In some embodiments, the lecithin is a co-surfactant. In some embodiments, the emulsion comprises filtered lecithin. A common syringe filter can be used for filtering. In some embodiments a 0.22 μm syringe filter is used. In some embodiments, the lecithin is a chemically modified lecithin. In some embodiments, the chemically modified lecithin is a hydroxylated lecithin. In some embodiments the lecithin is deodorized. In some embodiments, the lecithin has an enzymatic modification. In some embodiments, a ratio by weigh of RuBisCO protein isolate:lecithin is about 1:1. In some embodiments, a ratio by weigh of RuBisCO protein isolate:lecithin is up to 1, 2, 3, 5, 6, 7, 8, 9, 10, 15, 20, 50 times by weight. In some embodiments, a ratio by weigh of RuBisCO protein isolate:lecithin is up to about 1, 2, 3, 5, 6, 7, 8, 9, 10, 15, 20, 50 times by weight.

### Crosslinking Agent

In further examples, one or more other additives may also be included in the compositions described herein, such as glossing agents or crosslinking agents. A crosslinking agent may be used to promote desirable changes in a disclosed composition's physical properties, such as causing a polymer to: harden, have an increased melting temperature, etc. Crosslinks may also be formed by chemical reactions under heat, pressure, and/or pH changes. Example crosslinking agents included in compositions described herein include: calcium chloride, calcium phosphate, calcium sulfate, polysaccharides, formaldehyde, glutaraldehyde, dimethyl adipimidate, dimethyl suberimidate, glyoxal, and/or maleic anhydride, a gelling agent, a wax, among others. In some embodiments, wax may also be added to the mixture to provide additional stability to compositions disclosed herein. The wax may include a naturally-derived wax or a synthetic wax.

Compositions described herein can comprise about 0.1%, about 0.2%, about 0.3%, about 0.4%, about 0.5%, about 0.6%, about 0.7%, about 0.8%, about 0.9%, about 1%, about 1%, about 2%, about 3%, about 4%, about 5%, about 6%, about 7%, about 8%, about 9%, about 10%, or more by weight of a cross-linking agent. Compositions described herein can comprise about 0.1 g, about 0.2 g, about 0.3 g, about 0.4 g, about 0.5 g, about 0.6 g, about 0.7 g, about 0.8 g, about 0.9 g, about 1 g, about 1 g, about 2 g, about 3 g, about 4 g, about 5 g, about 6 g, about 7 g, about 8 g, about 9 g, about 10 g, or more of a cross-linking agent.

### Lipids

Compositions disclosed herein can further comprise one or more lipids. In some embodiments, the lipid is a solid lipid, an oil, butter or fat. In some embodiments, compositions disclosed herein can comprise a plant-based lipid, an animal-based lipid, a synthetic lipid, or combinations thereof. In some embodiments, compositions disclosed herein can comprise grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, oil from beans, such as garbanzo beans or fava beans, and the like. Compositions disclosed herein can comprise about 1%, about 2%, about 3%, about 4%, about 5%, about 7.5%, about 10%, about 15%, about 20%, about 25% or more weight of a liquid. Weight can be by dry weight or total weight. Compositions disclosed herein can comprise about 1 g, about 2 g, about 3 g, about 4 g, about 5 g, about 6 g, about 7 g, about 8 g, about 9 g, about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g, about 190 g, about 200 g, about 210 g, about 220 g, about 230 g, about 240 g, about 250 g, about 260 g, about 270 g, about 280 g, about 290 g, about 300 g, about 310 g, about 320 g, about 330 g, about 340 g, about 350 g, about 360 g, about 370 g, about 380 g, about 390 g, about 400 g or more of a lipid.

In some embodiments are compositions comprising fat solutions. In some embodiments the fat solution comprises RuBisCO protein isolate. In some embodiments the fat solution comprises an oil and RuBisCO protein isolate. In some embodiments the fat solution comprises an oil, RuBisCO protein isolate, and lecithin. In some embodiments the fat solution comprises coconut oil, RuBisCO protein isolate, and lecithin. In some embodiments, the fat solution is strained. In some embodiments the fat solution is part of an emulsion described herein. In some embodiments the fat solution is a part of an oil in water emulsion. In some embodiments, the fat solution is combined with a water solution to form an emulsion. In some embodiments, the fat solution is combined with a water solution wherein the water solution further comprises a polysaccharide.

As discussed, plant-based food products provide health benefits and eliminate the negative aspects of animal husbandry. Some non-protein based saturated fat replacements exist in the marketplace. However, almost every saturated fat replacer on the market utilizes starches, gums, or chemically modified starches or esters to generate a structured fat structure. There is currently a major push to generate new solid fat materials via plant-based products that do not rely on chemically modified polysaccharides or saturated fats to create solid fat structures. As such, the present disclosure provides methods that utilize a RuBisCO isolate as a fat binding agent to create plant-based generalized saturated fat replacements and specific fat mimetics utilized in meat analogues.

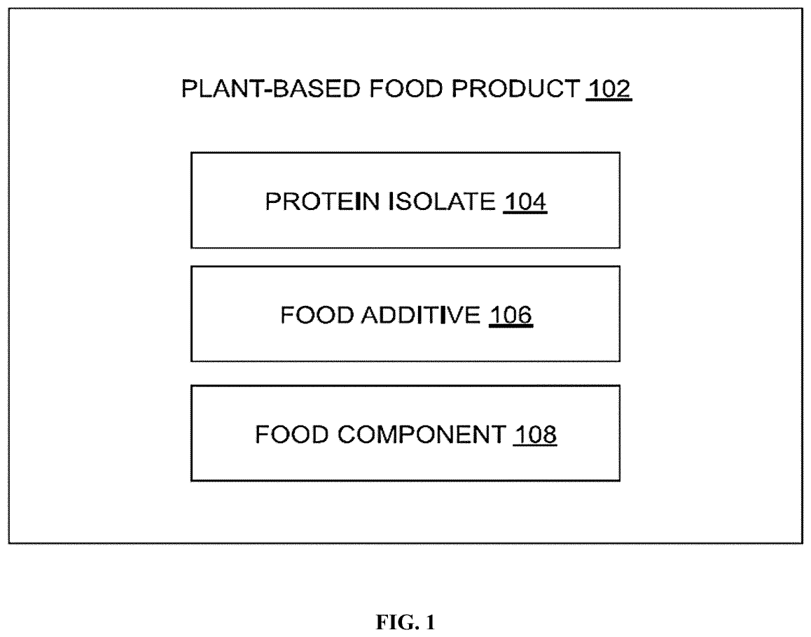

As shown in FIG. 1, a plant-based food product 102 is described and depicted that includes a protein isolate 104, a food additive 106 and optionally a food component 108. In examples, the protein isolate 104 comprises a ribulose-1,5-bisphosphate carboxylase/oxygenase (RuBisCO) protein isolate. In preferred examples, the RuBisCO protein isolate may be extracted from Lemna minor. Moreover, the RuBisCO protein isolate comprises a protein content greater than approximately 80% and is free of chlorophyll, is flavorless, and is colorless.

The food additive 106 includes a plasticizer, an oil, a flavoring component, and/or a coloring component, among other components not explicitly listed herein. In examples, the plasticizer is water. However, the plasticizer may be another component, such as a locust bean gum, a xanthan gum, and/or a guar gum, among other components not explicitly listed herein. The oil comprises a safflower oil, a grapeseed oil, and/or a canola oil, among other components not explicitly listed herein.

The flavoring component may be a paprika flavoring component, an onion powder flavoring component, a garlic powder flavoring component, a beet powder flavoring component, and/or a liquid smoke flavoring component, among others not explicitly listed herein. Moreover, the food component 108 may include a gluten, a yeast, a stock, a sauce, a syrup, a mustard, a paste, and/or a butter, among other components not explicitly listed herein. In preferred examples, the plant-based food product 102 comprises an emulsion that may be incorporated into other food products. More specifically, the plant-based food product 102 comprises the emulsion that is implemented into a meat structure in a liquid or solid form to generate a fat structure.

### Exemplary Embodiments

In some embodiments, the present disclosure and its embodiments relate to use of a RuBisCO protein isolate as a plant-based food product. In some embodiments, the present disclosure relates to the use of a RuBisCO protein isolate in an emulsion. In some embodiments, the present disclosure relates to the use of a RuBisCO protein isolate in a water-in-oil emulsion. In some embodiments, the present disclosure relates to the use of a RuBisCO protein isolate in an oil-in-water emulsion.

In some embodiments are compositions wherein the compositions comprise water-in-oil emulsion particles, wherein the water-in-oil emulsion particles comprise a protein isolate, wherein a majority of the protein in the isolate is ribulose-1,5-bisphosphate carboxylase/oxygenase (RuBisCO) protein isolate, a lipid, an aqueous liquid, and a surfactant. In some embodiments, the surfactant comprises at least one glycerophospholipid. In some embodiments, the at least one glycerophospholipid comprises phosphatidylcholine, phosphatidylethanolamine, phosphatidylinositol, phosphatidylserine, or phosphatidic acid. In some embodiments, the at least one glycerophospholipid comprises phosphatidylcholine, phosphatidylethanolamine, phosphatidylinositol, phosphatidylserine, and phosphatidic acid. In some embodiments, the surfactant is an emulsifier. In some embodiments, the emulsifier comprises a plant-based surfactant. In some embodiments, the emulsifier comprises lecithin. In some embodiments, the lecithin is from soybean, sunflower, and rapeseed. In some embodiments, the lecithin is present in an amount of up to about 2% by weight. In some embodiments, the lecithin is present in an amount of up to 1% by weight. In some embodiments, the water-in-oil emulsion particles comprises an average zeta potential surface charge more negative than at least about −30 mV. In some embodiments, the water-in-oil emulsion particles comprises an average zeta potential surface charge of −30 mV to −40 mV. In some embodiments, the water-in-oil emulsion particles comprise an average diameter of up to about 10 μm. In some embodiments, the water-in-oil emulsion particles comprise an average diameter of about 1 to about 5 μm. In some embodiments, the lipid is in liquid phase at 25 degrees Celsius. In some embodiments, the lipid comprises grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, or oil from beans. In some embodiments, the lipid comprises coconut oil. In some embodiments, the water-in-oil emulsion particles are in a ratio of lipid:aqueous liquid is at least 2:1 by weight. In some embodiments, the water-in-oil emulsion particles are in a ratio of lipid:aqueous liquid is at least about 8:1 by weight. In some embodiments, the RuBisCO is present in an amount of at least about 0.5% by dry weight. In some embodiments, the protein isolate present in an amount of up to about 15% by dry weight. In some embodiments, protein isolate is free of chlorophyll. In some embodiments, the protein isolate is flavorless and colorless. In some embodiments, the protein isolate comprises a large subunit and a small subunit of RuBisCO protein. In some embodiments, the protein isolate comprises protein comprising a sequence at least 90% identical to any one of SEQ ID NO: 1 to SEQ ID NO: 10. In some embodiments, the protein isolate comprises a protein comprising a sequence at least 95% identical to any one of SEQ ID NO: 1 to SEQ ID NO: 10. In some embodiments, the protein isolate comprises a protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. In some embodiments, the protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. In some embodiments, the protein isolate comprises a RuBisCO protein large subunit. In some embodiments, the protein isolate comprises a RuBisCO protein small subunit. In some embodiments, the protein isolate is from a plant in the Lemna genus. In some embodiments, the protein isolate is from a Lemna minor. In some embodiments, the protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris. In some embodiments, the protein isolate is from a single plant species. In some embodiments, the composition comprises a pH up to about 7.8. In some embodiments, the composition further comprises a plasticizer. In some embodiments, the plasticizer comprises a gum. In some embodiments, the gum is gum Arabic, a xanthan gum, a guar gum, or a locust bean gum. In some embodiments, the gum is xanthan gum. In some embodiments, the aqueous liquid is water. In some embodiments, the aqueous liquid comprises water and one or more acids. In some embodiments, the one or more acids comprises citric acid and/or ascorbic acid. In some embodiments are compositions comprising a composition described herein, wherein the composition is a food composition.

In some embodiments are plant-based food products comprising a protein isolate, and a food additive. In some embodiments, the food additive is selected from the group consisting of: a plasticizer, an oil, a flavoring component, and a coloring component. In some embodiments, the plasticizer comprises water. In some embodiments, the oil is selected from the group consisting of: a coconut oil, a safflower oil, a grapeseed oil, and a canola oil. In some embodiments, the flavoring component is selected from the group consisting of: a paprika flavoring component, an onion powder flavoring component, a garlic powder flavoring component, a beet powder flavoring component, and a liquid smoke flavoring component. In some embodiments, the protein isolate comprises a ribulose-1,5-bisphosphate carboxylase/oxygenase (RuBisCO) protein isolate. In some embodiments, the RuBisCO protein isolate comprises a protein content greater than approximately 80%. In some embodiments, the RuBisCO protein isolate is free of chlorophyll. In some embodiments, the RuBisCO protein isolate is flavorless and colorless. In some embodiments, the RuBisCO protein isolate is extracted from Lemna minor. In some embodiments, the plant-based food product further comprising: a food component. In some embodiments, the food component is selected from the group consisting of: a gluten, a yeast, a stock, a sauce, a syrup, a mustard, a paste, and a butter. In some embodiments, the plant-based food product comprises an emulsion. In some embodiments, the plant-based food product comprises a water-in-oil emulsion. In some embodiments, the oil-in-water emulsion comprises an aqueous phase optionally comprises a polysaccharide. In some embodiments, the emulsion comprises an oil phase comprising a ratio by weight of about 1:1 RuBisCO protein isolate:lecithin. In some embodiments, the emulsion is of a ratio of 90 weight percent oil and 10 weight percent water. In some embodiments, the 10 weight percent water comprises at least one polysaccharide. In some embodiments, the emulsion is implemented into a meat structure in a liquid or solid form to generate a fat structure. In some embodiments, the plant-based food product fails to comprise chemically modified polysaccharides or saturated fats.

In some embodiments, are compositions wherein the compositions comprise oil-in-water emulsion particles, wherein the oil-in-water emulsion particles comprise a protein isolate, wherein a majority of the protein in the isolate is ribulose-1,5-bisphosphate carboxylase/oxygenase (RuBisCO) protein isolate, a lipid, an aqueous liquid, and a surfactant. In some embodiments, the emulsifier comprises a plant-based surfactant. In some embodiments, the emulsifier comprises lecithin. In some embodiments, the lecithin is from soybean, sunflower, and rapeseed. In some embodiments, the lecithin is present in an amount of up to about 2% by weight. In some embodiments, the lecithin is present in an amount of up to 1% by weight. In some embodiments, the oil-in-water emulsion particles comprises an average zeta potential surface charge more negative than at least about −30 mV. In some embodiments, the oil-in-water emulsion particles comprises an average zeta potential surface charge of −30 mV to −40 mV. In some embodiments, the oil-in-water emulsion particles comprise an average diameter of up to about 10 μm. In some embodiments, the oil-in-water emulsion particles comprise an average diameter of about 1 to about 5 μm. In some embodiments, the lipid is in liquid phase at 25 degrees Celsius. In some embodiments, the lipid comprises grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, or oil from beans. In some embodiments, the lipid comprises coconut oil. In some embodiments, the oil-in-water emulsion particles are in a ratio of lipid:aqueous liquid is at least 2:1 by weight. In some embodiments, the oil-in-water emulsion particles are in a ratio of lipid:aqueous liquid is at least about 8:1 by weight. In some embodiments, the RuBisCO is present in an amount of at least about 0.5% by dry weight. In some embodiments, the protein isolate present in an amount of up to about 15% by dry weight. In some embodiments, protein isolate is free of chlorophyll. In some embodiments, the protein isolate is flavorless and colorless. In some embodiments, the protein isolate comprises a large subunit and a small subunit of RuBisCO protein. In some embodiments, the protein isolate comprises protein comprising a sequence at least 90% identical to any one of SEQ ID NO: 1 to SEQ ID NO: 10. In some embodiments, the protein isolate comprises a protein comprising a sequence at least 95% identical to any one of SEQ ID NO: 1 to SEQ ID NO: 10. In some embodiments, the protein isolate comprises a protein comprising a sequence of SEQ ID NO: 1 or 2; SEQ ID NO: 3 or 4; SEQ ID NO: 5 or 6; SEQ ID NO: 7 or 8; or SEQ ID NO: 9 or 10. In some embodiments, the protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10. In some embodiments, the protein isolate comprises a RuBisCO protein large subunit. In some embodiments, the protein isolate comprises a RuBisCO protein small subunit. In some embodiments, the protein isolate is from a plant in the Lemna genus. In some embodiments, the protein isolate is from a Lemna minor. In some embodiments, the protein isolate is from a Lemna aequinoctialis, Lemna disperma, Lemna ecuadoriensis, Lemna gibba, Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris. In some embodiments, the protein isolate is from a single plant species. In some embodiments, the composition comprises a pH up to about 7.8. In some embodiments, the composition further comprises a plasticizer. In some embodiments, the plasticizer comprises a gum. In some embodiments, the gum is gum Arabic, a xanthan gum, a guar gum, or a locust bean gum. In some embodiments, the gum is xanthan gum. In some embodiments, the aqueous liquid is water. In some embodiments, the aqueous liquid comprises water and one or more acids. In some embodiments, the one or more acids comprises citric acid and/or ascorbic acid. In some embodiments are compositions comprising a composition described herein, wherein the composition is a food composition.

In some embodiments are plant-based food products comprising a protein isolate, and a food additive. In some embodiments, the food additive is selected from the group consisting of: a plasticizer, an oil, a flavoring component, and a coloring component. In some embodiments, the plasticizer comprises water. In some embodiments, the oil is selected from the group consisting of: a coconut oil, a safflower oil, a grapeseed oil, and a canola oil. In some embodiments, the flavoring component is selected from the group consisting of: a paprika flavoring component, an onion powder flavoring component, a garlic powder flavoring component, a beet powder flavoring component, and a liquid smoke flavoring component. In some embodiments, the protein isolate comprises a ribulose-1,5-bisphosphate carboxylase/oxygenase (RuBisCO) protein isolate. In some embodiments, the RuBisCO protein isolate comprises a protein content greater than approximately 80%. In some embodiments, the RuBisCO protein isolate is free of chlorophyll. In some embodiments, the RuBisCO protein isolate is flavorless and colorless. In some embodiments, the RuBisCO protein isolate is extracted from Lemna minor. In some embodiments, the plant-based food product further comprising: a food component. In some embodiments, the food component is selected from the group consisting of: a gluten, a yeast, a stock, a sauce, a syrup, a mustard, a paste, and a butter. In some embodiments, the plant-based food product comprises an emulsion. In some embodiments, the plant-based food product comprises an oil-in-water emulsion. In some embodiments, the oil-in-water emulsion comprises an aqueous phase optionally comprises a polysaccharide. In some embodiments, the emulsion comprises an oil phase comprising a ratio by weight of about 1:1 RuBisCO protein isolate:lecithin. In some embodiments, the emulsion a ratio of 90 weight percent oil and 10 weight percent water. In some embodiments, the 10 weight percent water comprises at least one polysaccharide. In some embodiments, the emulsion is implemented into a meat structure in a liquid or solid form to generate a fat structure. In some embodiments, the plant-based food product fails to comprise chemically modified polysaccharides or saturated fats.

In some embodiments, a composition comprising a plant-based food product comprises: a protein isolate; and a food additive. In some embodiments, the food additive is selected from the group consisting of: a plasticizer, an oil, a flavoring component, and a coloring component. In some embodiments, the plasticizer comprises water. In some embodiments, the oil is selected from the group consisting of: a safflower oil, a grapeseed oil, and a canola oil. In some embodiments, the flavoring component is selected from the group consisting of: a paprika flavoring component, an onion powder flavoring component, a garlic powder flavoring component, a beet powder flavoring component, and a liquid smoke flavoring component. In some embodiments, the protein isolate comprises a ribulose-1,5-bisphosphate carboxylase/oxygenase (RuBisCO) protein isolate. In some embodiments, the RuBisCO protein isolate comprises a protein content greater than approximately 80%. In some embodiments, the RuBisCO protein isolate is free of chlorophyll. In some embodiments, the RuBisCO protein isolate is flavorless and colorless. In some embodiments, the RuBisCO protein isolate is extracted from Lemna minor.

In some embodiments, a composition comprising a plant-based food product as described herein, further comprising a food component. In some embodiments, the food component is selected from the group consisting of: a gluten, a yeast, a stock, a sauce, a syrup, a mustard, a paste, and a butter. In some embodiments, the plant-based food product comprises an emulsion. In some embodiments, the emulsion is implemented into a meat structure in a liquid or solid form to generate a fat structure. In some embodiments, the plant-based food product fails to comprise chemically modified polysaccharides or saturated fats.

In some embodiments, a composition herein comprises an emulsion, wherein the emulsion is an oil-in-water emulsion, and wherein the emulsion comprises: 50-85% water by weight; up to about 5% polysaccharide by weight; 15-25% coconut oil by weight; up to about 15% lecithin by weight; and up to about 15% RuBisCO protein isolate by weight. In some embodiments, the emulsion is an oil-in-water emulsion, and the emulsion comprises: about 85% water by weight; up to about 0.1% polysaccharide by weight; about 25% coconut oil by weight; up to about 0.1% lecithin by weight; and up to about 0.1% RuBisCO protein isolate by weight. In some embodiments, the emulsion is an oil-in-water emulsion, the polysaccharide comprises konjac-xanthan, and the emulsion comprises: 79.8% water by weight; up to about 0.2% konjac-xanthan by weight; 19.5% coconut oil by weight; up to about 0.25% lecithin by weight; and up to about 0.25% RuBisCO protein isolate by weight. In some embodiments, the emulsion is an oil-in-water emulsion, the polysaccharide comprises curdlan, and the emulsion comprises: 79.8% water by weight; up to about 1% curdlan by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises agar, and the emulsion comprises: about 79.8% water by weight; up to about 1% agar by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises pectin, and the emulsion comprises: about 79.8% water by weight; up to about 0.8% pectin by weight; about 19.5% coconut oil by weight; up to about 0.25% lecithin by weight; and up to about 0.25% RuBisCO protein isolate by weight. In some embodiments, the emulsion is an oil-in-water emulsion, the polysaccharide comprises kappa carrageenan, and the emulsion comprises: about 79.8% water by weight; up to about 0.8% kappa carrageenan by weight; 19.5% coconut oil by weight; up to about 0.25% lecithin by weight; and up to about 0.25% RuBisCO protein isolate by weight. In some embodiments, are food products comprising an emulsion described herein. In some embodiments, are methods of manufacturing a food product, the method comprising mixing the composition or the plant-based food product described above with another ingredient.

### EXAMPLES

### Example 1: Safflower Oil Emulsion

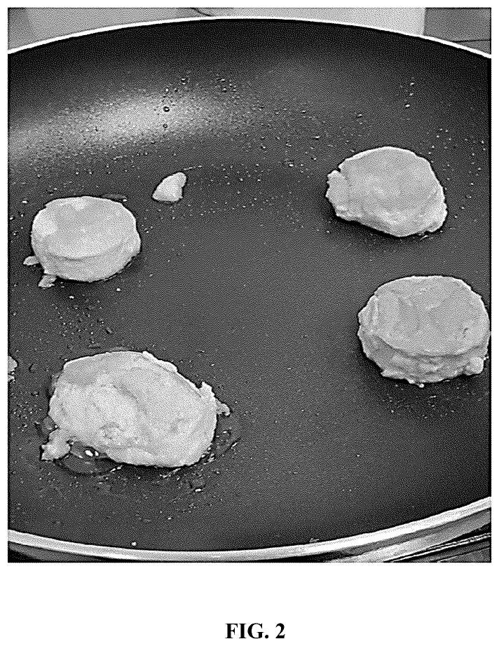

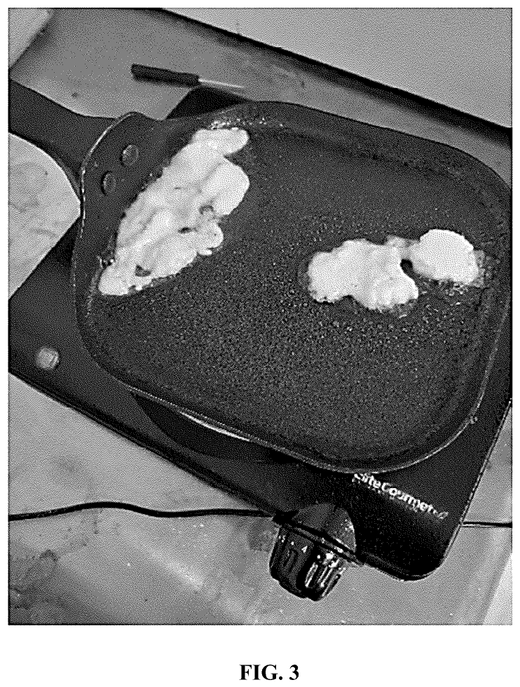

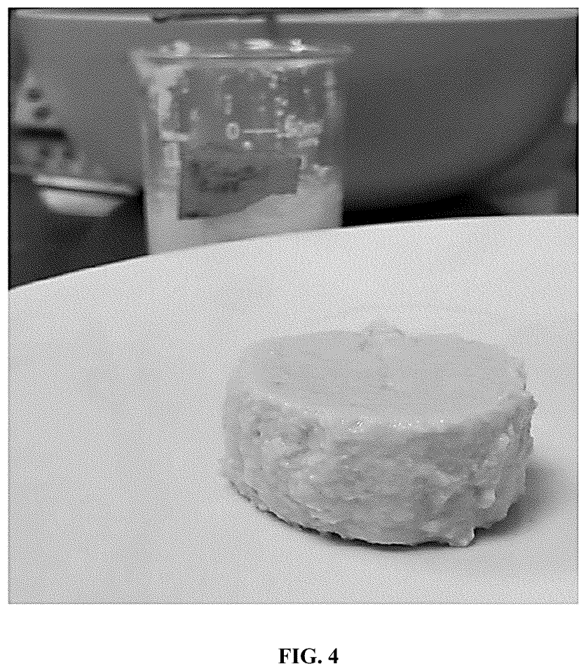

In a first example, a safflower oil emulsion is prepared. A Lemna minor plant protein isolate comprising RuBisCO is first dissolved in about 42.5-48 wt. % of water at about 2, 5 or 7.5 wt. % concentration. A safflower oil is added to the solution at about 50 wt. %. The solution is then emulsified using a high-speed homogenizer for about two minutes. The resulting emulsion is stable and is white to off-white in color. The safflower oil emulsion is used to make plant-based food products, as shown in FIG. 2, FIG. 3, and FIG. 4.

### Example 2: Solid Saturated Fat Mimetics

The safflower oil emulsion of Example 1 is gelled at about 95° C. for about 30 minutes in a water bath. The emulsion is then cooled at about 4ºC until the emulsion reaches about 25° C. The solidified emulsion can then be removed from the beaker or mold.

The strength of the gelled emulsions increases with the increase in the content of the Lemna minor plant protein isolate comprising RuBisCO. Cooking the solidified emulsion renders a varied amount of fat, with about 2 wt. % of the RuBisCO protein isolate releasing the highest amount of fat and about 7.5 wt. % of the RuBisCO protein isolate rendering almost no fat.

### Example 3: Marbled Steak

A base seitan steak is made using the following components: about 42.02 wt. % of vital wheat gluten, about 2.10 wt. % of nutritional yeast, about 0.07 wt. % of a paprika powder flavoring component, about 0.01 wt. % of an onion powder flavoring component, about 0.01 wt. % of a garlic powder flavoring component, about 0.45 wt. % of a beat powder flavoring component, about 16.81 wt. % of a vegetable stock, about 7.73 wt. % of a canola oil, about 8.40 wt. % of a tamari sauce, about 11.51 wt. % of a maple syrup, about 4.12 wt. % of a liquid smoke flavoring component, about 2.16 wt. % of a Dijon mustard and about 4.58 wt. % of a tomato paste.

In this example, the dry and wet components were combined, kneaded for about 5-8 minutes, and then shaped into a cylinder. The steak was then punctured with a knife in several places and approximately 100-150 mL of about 7.5 wt. % of the RuBisCO emulsion (e.g., the safflower oil emulsion of Example 1) was forced into the steak using a pipette. The steak was then steamed for about 25-30 minutes and then cooled at about 4° C.

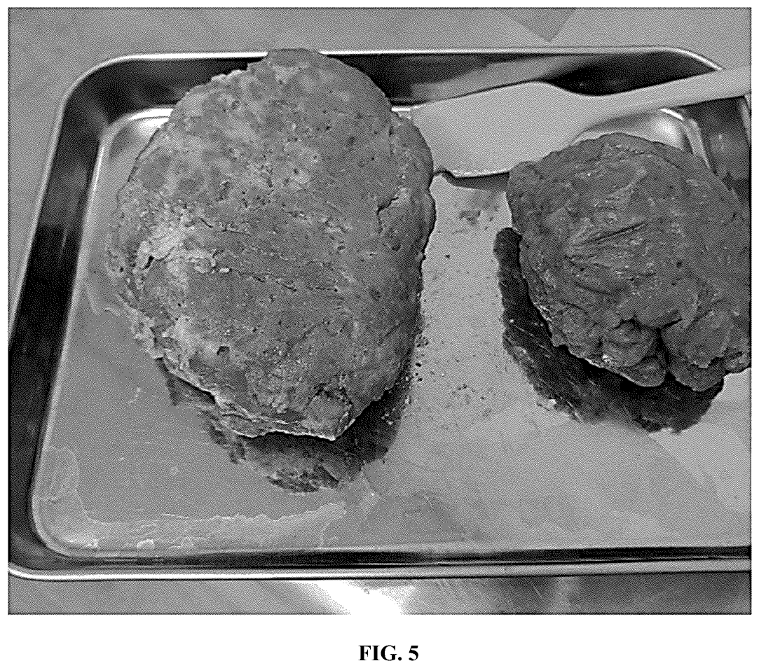

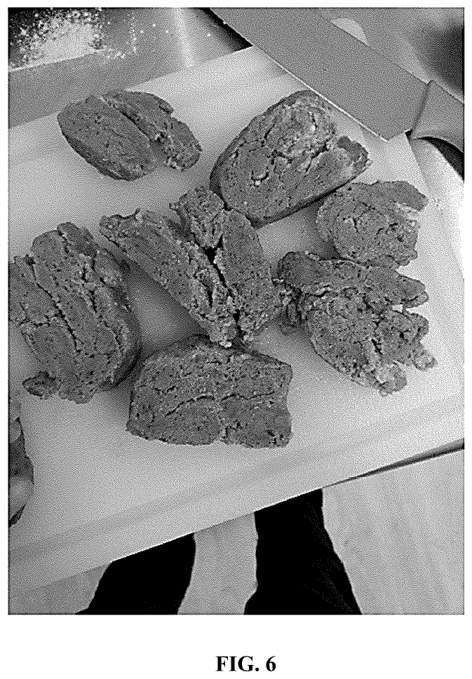

The resulting steak with the RuBisCO emulsion (e.g., the safflower oil emulsion of Example 1) had the appearance of marbled steak due to the gelled RuBisCO emulsion throughout. The cooked steak had a more juicy texture as compared to a control steak that did not use the RuBisCO emulsion (e.g., the safflower oil emulsion of Example 1). The plant-based marbled steak food product is depicted in FIG. 5 and FIG. 6 herein.

### Example 4: Lardons/Bacon

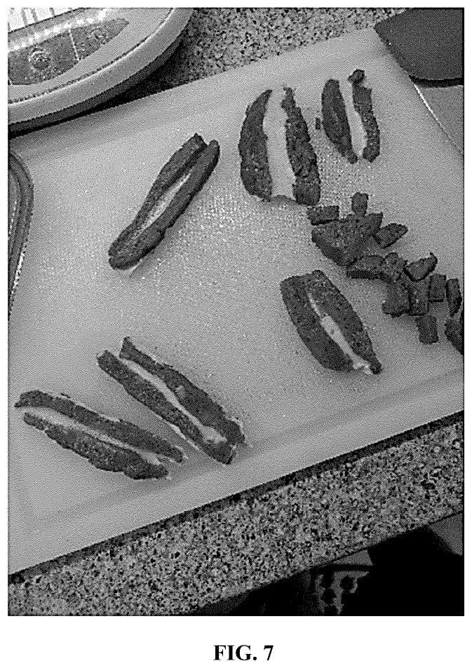

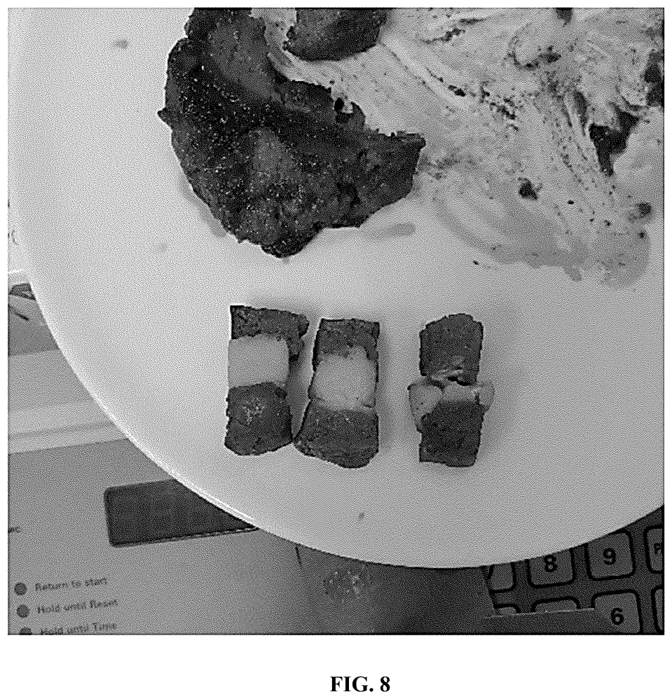

The seitan base steak from Example 3 was steamed for about 20 minutes, then cooled at about 4ºC. The seitan base steak was then cut into thin strips and placed into an aluminum foil mold. The about 7.5% RuBisCO emulsion (e.g., the safflower oil emulsion of Example 1) was pipetted in between the slices to generate a bacon or lardon like pattern or seitan “lean” phase and the RuBisCO emulsion (e.g., the safflower oil emulsion of Example 1) “fat” phase. The material in the mold was then steamed for about 25-30 minutes and cooled at about 4° C. The resulting materials had the appearance of bacon or lardons and crisped during cooking. The final texture was similar to bacon or lardons. The plant-based lardons/bacon food product is depicted in FIG. 7, FIG. 8, and FIG. 9 herein.

### Example 5: Cocoa Butter Emulsion

A cocoa butter emulsion includes about 2-7.5 wt. % of a RuBisCO protein isolate, about 42.5-48 wt. % of water, and about 70 wt. % of a coca butter.

In this example, about 2, 5 or 7.5 wt. % concentration of the RuBisCO protein isolate is dissolved in about 42.5-48 wt. % of the water. Next, about 70 wt. % of the cocoa butter is added to the solution. The solution is emulsified using a high-speed homogenizer for about two minutes. The resulting emulsion is stable and appears white to off-white in color.

### Example 6: Solid Saturated Fat Mimetics

The cocoa butter emulsion of Example 5 is gelled at about 95° C. for about 30 minutes in a water bath. The emulsion is then cooled at about 4° C. until the emulsion at least reached about 25° C. The solidified emulsion can then be removed from the beaker or mold.

The strength of the gelled emulsions increases with an increase in the RuBisCO protein isolate content. The strength of the gelled emulsion was stronger than those made with the safflower oil (e.g., the safflower oil emulsion of Example 1). Cooking the solidified emulsion renders varied amount of fat, with about 2 wt. % of the RuBisCO protein isolate releasing the highest amount of fat and about 7.5 wt. % of the RuBisCO protein isolate rendering almost no fat.

Specifically, the present disclosure provided herein highlights the excellent native gelling capabilities and emulsifying properties of RuBisCO when RuBisCO is applied to saturated fat replacement applications. The RuBisCO protein isolate is able to gel upon heating and form a gel that has similar or slightly higher strength to that of an egg white. Additionally, the RuBisCO protein isolate is able to emulsify added fats without the addition of other emulsifiers. Differing from solutions in this field, the present disclosure provides new solid fat materials made via plant-based products that do not rely on chemically modified polysaccharides or saturated fats to create solid fat structures. In fact, RuBisCO is novel in the way that it can create thermally gelled emulsions that render fats in a concentration dependent nature and be implemented into meat structures in a liquid or solid form to generate fat structures.

As such, the present disclosure: provides clean label gelation properties, has a high emulsification ability with no added emulsifier, has a complete protein nutritional profile, is able to form a stable emulsion that is thermally gelled, is able to render an oil during cooking in a RuBisCO concentration manner, and provides an adhesion to plant-based meat materials.

### Fat Mimetic Characterization

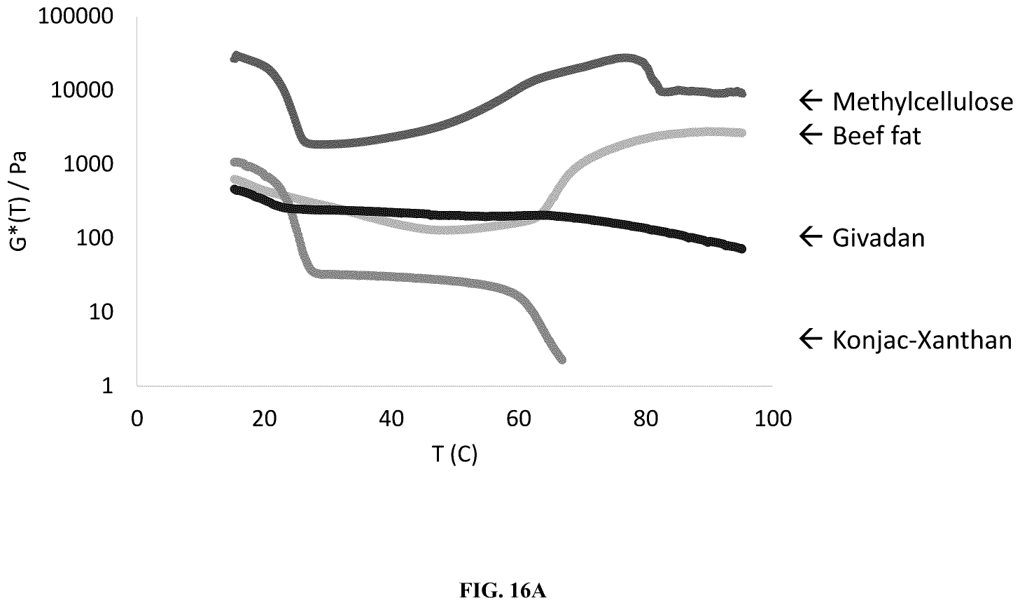

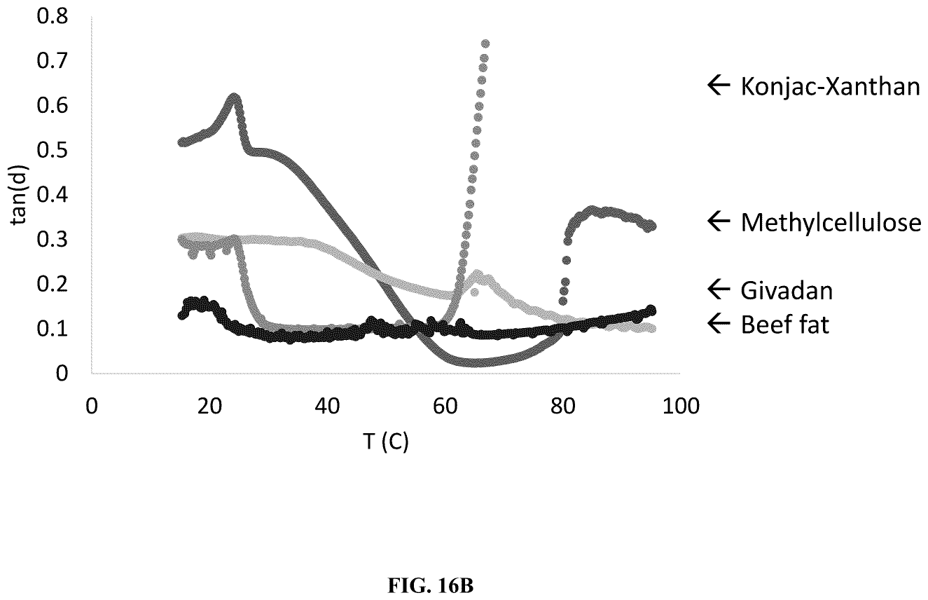

Characterization of reference fat and fat mimetic products were also carried out and analyzed. Reference materials in the form of oil-in-water emulsions screened included a methylcellulose fat with coconut oil, Konjac-Xanthan/lecithin fat with coconut oil, commercial fat from Givadan, and beef fat. Resistance to deformation of the fat material was measured at different temperatures as shown in FIG. 16A-16B. Weaker responses (lower G* values) can be associated with melting, a glass transition, or other decomposition. Stronger responses (higher G* values) can be associated increased gelation, and/or other material strengthening processes. FIG. 16A show a decay consistent with the liquification of fat (coconut or other otherwise) which are present in RuBisCO oil-in-water emulsions. Secondary decay curves were consistent with melting or a glass transition. The increase in G*(T) seen in the methylcellulose blend was consistent with thermal gelation. The increase in G*(T) seen in the beef fat may be due to heating. The Konjac-Xanthan blended melted around 70 degrees Celsius and could not be analyzed at higher temperatures. Weakening observed for the emulsions can also be attributed, in part, to the polysaccharide component of the metrix undergoing a glass transition, or melting. Another analysis to measure liquid or solid-like responses to resistance can be interpreted using a tangent function analysis as shown in FIG. 16B. Fluids with a tan(d)>1 are more liquid-like, whereas fluids with tan(d)<1 are more solid like. The commercial fat product from Givadan, which can be used as a very close approximation to real beef fat, was consistently solid-like through the entire temperature range of exposure. “Cooking” the fat appears to increase solid-like behavior of the fat mimetic material. The methylcellulose formulation became more solid-like over the sampled temperature range, consistent with thermal gelation. The Konjac-xanthan gum melted at approximately 62 degrees Celsius, however, exhibited behavior similar to the Givadan sample prior to heating all the way to 62 degrees. Before the Konjac-xanthan gum emulsion melted, it did exhibit similar emulsion behavior to the Givadan behavior prior to the melting point.

### Example 7: Protein Isolation and Purification

### Example 7.1: Workflow A

One kg of fresh Lemna minor was macerated in a Vitamix Blender (Vitamix Corp, Cleveland, Ohio) in a ratio of 1:1 with a sodium carbonate buffer containing 0.3% w/v sodium bisulfite. The extraction was performed for 3 minutes at medium speed setting maintaining the temperature at less than 30° C. Subsequently, the macerated biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The solution was heated to a temperature of 50° C. in a aqueous liquid bath that was set at a temperature of 55° C. and was cooled rapidly to a temperature less than 15° C. after reaching the target temperature. Following the rapid cooling of the protein solution, 2% v/v of activated chitosan and 4% w/v of activated carbon (Cabot Norit Americas Inc, Marshall, Texas) is added to the liquid juice. The solution was subsequently stirred for 5 minutes after which the solution was centrifuged for 10 minutes at a speed/force of 5000 g (Allegra X15R, SX4750 rotor; Beckman Coulter, Inc., Pasadena, California). The green pellet in the centrifuge bottle was discarded, and the clear yellow supernatant was micro filtered using a 0.7 pm Glass Micro fiber membrane (Whatman 1825-047 Glass Microfiber Binder Free Filter, 0.7 Micron; Global Life Sciences Solutions USA LLC, Marlborough, Massachusetts). The filtrate was subsequently exposed to a 0.2 pm polyethersulfone membrane (Polyethersulfone (PES) Membrane Filters, 0.2 Micron; Sterlitech Corporation Inc, Kent, Washington) to remove the remainder of the undesired particles including bacteria. The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless and soluble protein powder.

### Example 7.2: Workflow B

One kg of fresh Lemna minor was macerated using a Vitamix Blender (Vitamix Corp, Cleveland, Ohio) in a ratio of 1:1 with a potassium phosphate buffer containing 0.3% w/v ascorbic acid. The maceration was performed for a period of 3 minutes at medium speed in order to maintain a temperature of less than 30° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The supernatant was then mixed with 5% v/v of activated chitosan (Chitosan (10-120 cps), fungal origin (9012-76-4); Glentham Life Sciences Ltd., Corsham, Wiltshire, UK) and 10% w/v of activated carbon (Cabot Norit Americas Inc, Marshall, Texas) for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded, and the deodorized and decolored supernatant was microfiltered using a 0.2 pm polyethersulfone membrane (Polyethersulfone (PES) Membrane Lilters, 0.2 Micron; Sterlitech Corporation Inc, Kent, Washington). The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless and soluble protein powder.

### Example 7.3: Workflow C

One kg of fresh Lemna minor was macerated using a Vitamix Blender (Vitamix Corp, Cleveland, Ohio) in a ratio of 1:1 with distilled aqueous liquid containing 0.3% w/v of sodium bisulfite and ascorbic acid. The maceration was performed for a period of 3 minutes at medium speed in order to maintain a temperature of less than 30° ° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g. The pellet was discarded, and the supernatant was collected separately. The supernatant was then mixed with a solution containing 30 mM of potassium phosphate and 20 mM of calcium chloride for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded. 5% w/v of activated carbon (Cabot Norit Americas Inc, Marshall, Texas) was added to the supernatant, and the solution was stirred for 5 minutes. Subsequently, the mixed solution containing the activated carbon was micro filtered using a 0.2 pm polyethersulfone membrane filter (Polyethersulfone (PES) Membrane Filters, 0.2 Micron; Sterlitech Corporation Inc, Kent, Washington) in order to remove the activated carbon that had adsorbed the remaining chlorophyll, polyphenol and other unwanted taste/color/odor impacting particles. The obtained pale yellow and deodorized proteinaceous solution was then concentrated using a 100 kDa membrane (Hollow Fiber Cartridge, 100,000 NMWC, 850 cm2; GE Healthcare Bio-Sciences Corp, Westborough, Massachusetts). The concentrated solution obtained was subsequently freeze dried and the result was a white, odorless and soluble protein powder.

### Example 7.4: Workflow D

One kg of fresh Lemna minor was macerated using a Vitamix Blender (Vitamix Corp, Cleveland, Ohio) in a ratio of 1:1 with distilled aqueous liquid containing 0.5% w/v of sodium bisulfite. The maceration was performed for a period of 3 minutes at medium speed in order to maintain a temperature of less than 30° C. The lysed biomass was filtered by using a nylon straining bag (Natural Home Brands, Sun Valley, California) with a fine mesh to separate the fibrous high solids cake from the liquid juice containing the soluble protein. The filtered homogenate was then centrifuged for 10 minutes at a speed/force of 4000 g (Allegra X15R, SX4750 rotor; Beckman Coulter, Inc., Pasadena, California). The pellet was discarded, and the supernatant was collected separately. The supernatant was then mixed with a solution containing 30 mM of potassium phosphate and 20 mM of calcium chloride for a period of 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded. 2% w/v of activated chitosan (Chitosan (10-120 cps), fungal origin (9012-76-4); Glentham Life Sciences Ltd., Corsham, Wiltshire, UK) and 4% of activated carbon (Cabot Norit Americas Inc, Marshall, Texas) were added to the supernatant, and the solution was stirred for 5 minutes. Subsequently the mixed solution was centrifuged at a speed/force of 5000 g for 10 minutes (Allegra X15R, SX4750 rotor; Beckman Coulter, Inc., Pasadena, California). The obtained pellet was discarded, and the deodorized and decolored supernatant was microfiltered using a 0.7 pm polyethersulfone membrane (Whatman 1825-047 Glass Microfiber Binder Free Filter, 0.7 Micron; Global Life Sciences Solutions USA LLC, Marlborough, Massachusetts). The filtrate was then further microfiltered using a 0.2 pm polyethersulfone membrane (Polyethersulfone (PES) Membrane Filters, 0.2 Micron; Sterlitech Corporation Inc, Kent, Washington). The obtained pale yellow and deodorized proteinaceous solution was then concentrated using a 70 kDa membrane (MINIKROS® S02-E070-05-N; Spectrum Laboratories, Inc., Rancho Dominguez, California). The concentrated solution obtained was subsequently freeze dried (Harvest Right LLC, Salt Lake City, Utah) and the result was a white, odorless and soluble protein powder.

### Example 7.5: Purity Analysis from Workflows A-D

The average purity of the protein preparations prepared by the methods of Workflows A-D was about 84.3% and the concentration of soluble protein after ultrafiltration was 1,316 pg/mL. The foaming capacity achieved was 195% and maintained a 92% stability after 1 hour. Gelation properties of the freeze-dried material were validated, and only 2% w/v of freeze-dried material was needed to be added in order to form a gel.

Further analysis of the protein samples was carried out to determine percentage RubisCO in the Lemna minor protein isolate. On average, RuBisCO purity was between 65% and 78% of the protein isolate (data not shown). Additionally, pre-filtration as previously described did not noticeably affect observed protein composition. Protein isolate consistent with the methods above, was analyzed for two samples over time stored at 42-45 degrees C. as shown in TABLE 3.

TABLE 3
Protein Sample Analysis Over Time

| | Vacuum drying | | | | Total Protein | | Water Activity | |
|---|---|---|---|---|---|---|---|---|
| | moisture | | pH | | (percentage) | | (a_{w}) | |
| | Sample | Sample | Sample | Sample | Sample | Sample | Sample | Sample |
| Time | 1 | 2 | 1 | 2 | 1 | 2 | 1 | 2 |
| At start | 3.22 | 3.29 | 6.36 | 6.35 | 84.13 | 84.27 | 0.154 | 0.148 |
| 2 months | 2.47 | 2.49 | — | — | — | — | 0.194 | 0.191 |
| 4 months | 2.54 | 2.52 | — | — | — | — | 0.197 | 0.205 |
| 5 months | 4.10 | 4.15 | — | — | — | — | 0.295 | 0.285 |
| 6 months | 3.32 | 3.04 | — | — | — | — | 0.344 | 0.348 |
| 7 months | 3.11 | 3.04 | — | — | 85.30 | 84.77 | 0.198 | 0.189 |

Water activity (aw), is a measure of how much of the water content in the protein is free (i.e., unbound), and thus available to microorganisms to use for growth. This is important with regard to food safety. The aw of a food is the ratio between the vapor pressure of the food, itself, when in a completely undisturbed balance with the surrounding air media, and the vapor pressure of distilled water under identical conditions. Organoleptic evaluation was also conducted for the samples described in TABLE 3. This included evaluation of: appearance, color, texture, and visual representation (data not shown). Both samples shown no remarkable abnormalities in appearance or texture, no discoloration, and no abnormalities in visual representation through month 4 of analysis. Analysis for months 5, 6, and 7 showed normal representation for appearance, color, texture, and visual representation.

### Example 8: Fat Replacement with RuBisCO

Oil-in-water RuBisCO emulsions comprising 80% aqueous solutions with 20% fat (oil) solutions were prepared for use as fat replacement products using RuBisCO.

A control oil-in-water emulsion without RuBisCO was prepared using a lecithin-konjac/xanthan formulation. The oil-in-water emulsion was prepared with the aqueous phase structured further comprising a polysaccharide or a blend of polysaccharides. The composition was prepared according to TABLE 4.

TABLE 4
Exemplary Fat Replacement Formulation

| Ingredient | Percentage | Weight (grams) |
|---|---|---|
| Water | 79.8% | 319.2 |
| Konjac Xanthan (KX) | 0.2% | 0.8 |
| Oil | 19.5% | 78 |
| Lecithin | 0.5% | 2 |

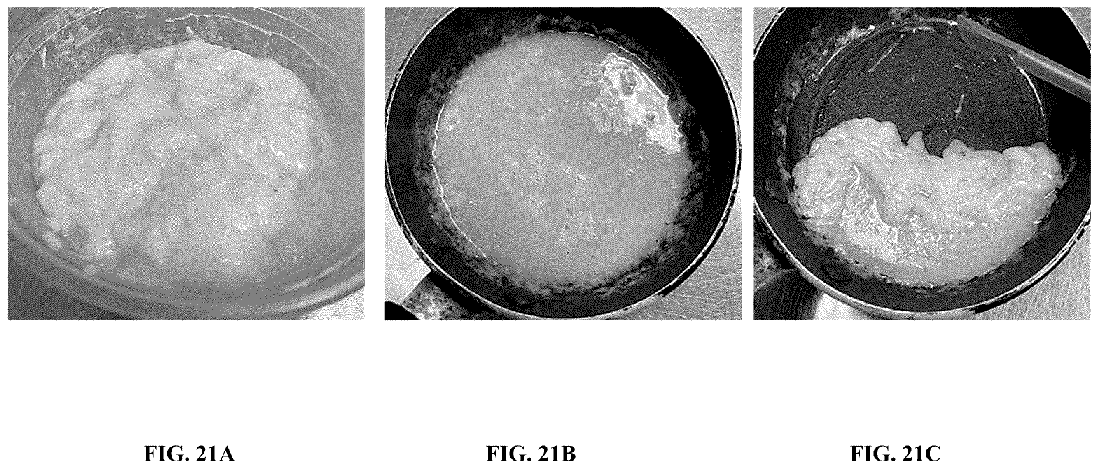

The KX and water were mixed until the KX was dispersed. The mixture was then heated in a thermomix to 90 degrees Celsius. Separately, coconut oil was melted at about 40 degrees Celsius in a beaker, the lecithin was added to the beaker and mixed until dispersed. The oil mixture was added to the thermomix and mixed on high speed for approximately 5 minutes. The combined mixture was subsequently transferred to a third container and refrigerated overnight. A minimum of 350 g scale resulted in a formula size compatible with the thermomix. The resulting emulsion was characterized as a gelatinous slime material with melting properties, and the ability to resolidify into a viscous gel as shown in FIG. 21A-21C. It was also observed that, when melted, the oil droplets did appear from the solution, suggesting that the emulsion was not completely cohesive. Finally, it was also observed that the gel was easy to manipulate, and the gel did not hold together in a single block.

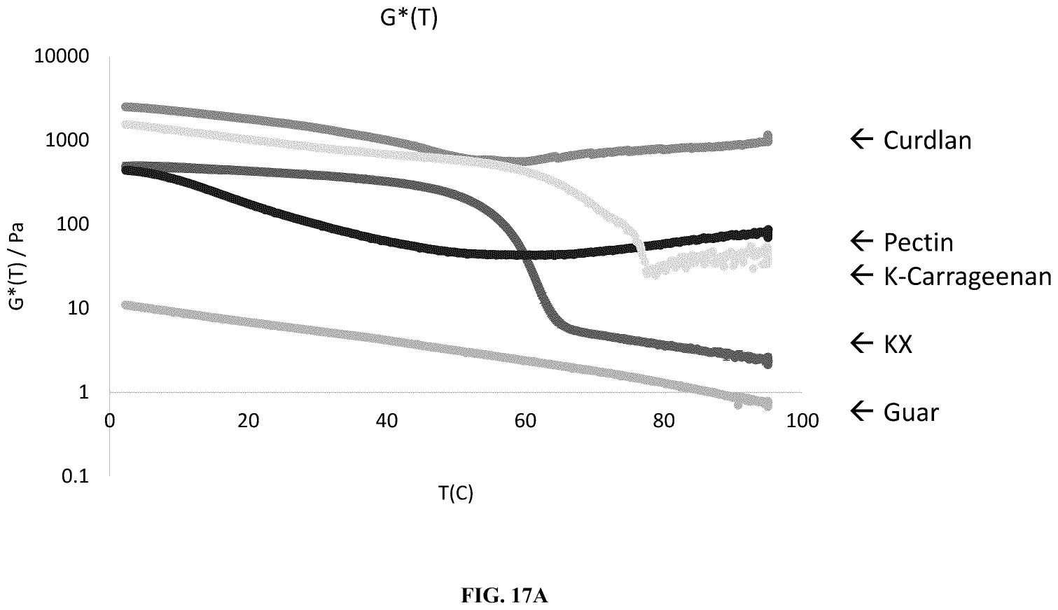

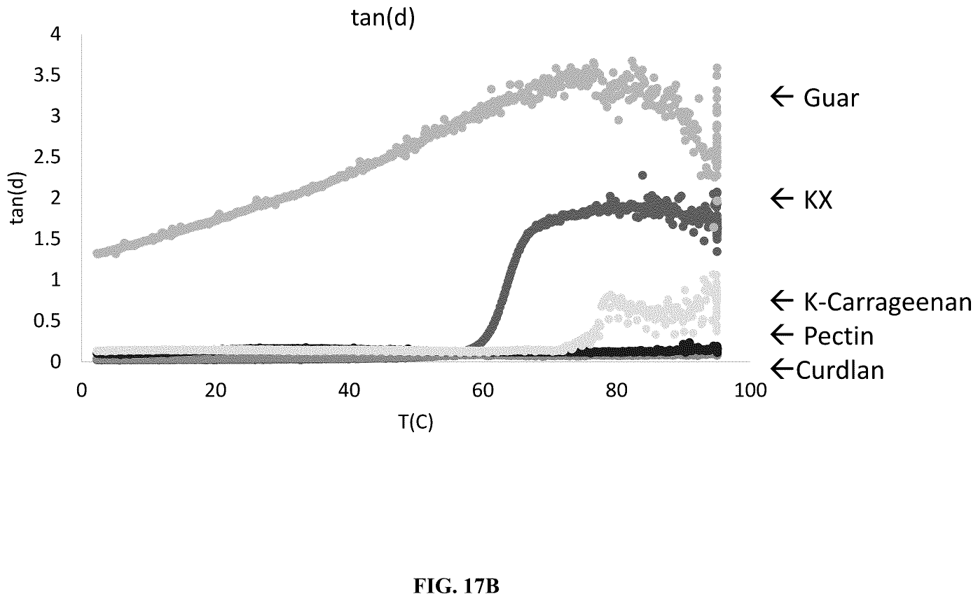

Using the above formulation, additional oil-in-water emulsions were prepared using other polysaccharides in place of the KX. The oil-in-water emulsions prepared with different polysaccharides included: agar, guar, pectin (with calcium in the form of 3.75 mM CaCl₂)), K-carageenan (with potassium in the form of 0.5 weight % of KCl), or curdlan (5% by weight used instead of the 0.2% by weight as used for the other polysaccharide emulsions). Rheological properties for each oil-in-water emulsion were analyzed and results shown in FIG. 17A-17B.

The above oil-in-water emulsion containing Konjac-Xanthan was then prepared with 0.25% RuBisCO added to a 20% fat solution similar to the above, containing the 0.25% lecithin as shown in TABLE 5.

TABLE 5
Exemplary Fat Replacement Formulation - Konjac Xanthan (KX)

| Ingredient | Percentage | Weight (grams) |
|---|---|---|
| Water | 79.8% | 319.2 |
| Konjac Xanthan (KX) | 0.2% | 0.8 |
| Coconut Oil | 19.5% | 78 |
| Lecithin | 0.25% | 1 |
| RuBisCO | 0.25% | 1 |

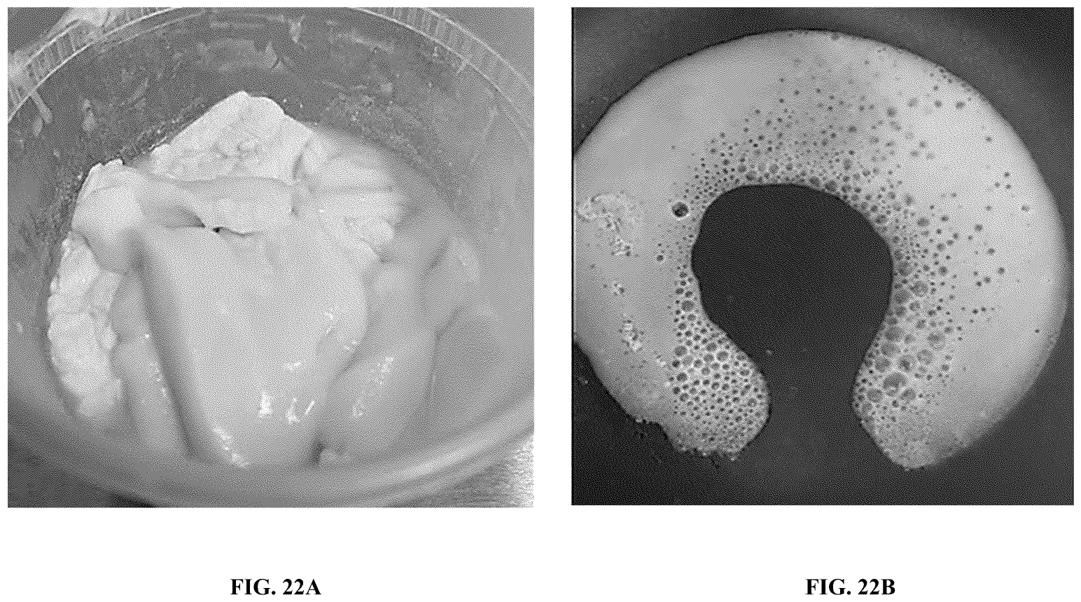

The mixture was prepared as presented above. The RuBisCO was added with the lecithin to the melted coconut oil, wherein the subsequent mixture is combined as described for the control oil-in-water emulsions above. The resulting oil-in-water RuBisCO emulsion containing 1:1 RuBisCO:Lecithin exhibited a gelatinous flan-like material (FIG. 22A) that held its shape relatively well and was more difficult to perturb than the control (RuBisCO-free) emulsion. When melted (FIG. 22B), similar to the control, oil droplets were visible.

TABLE 6
Exemplary Fat Replacement Formulation - Curdlan)

| Ingredient | Percentage | Weight (grams) |
|---|---|---|
| Water | 79.8% | 319.2 |
| Curdlan | 1% | 4 |
| Coconut Oil | 19.5% | 78 |
| Lecithin | 0.25% | 1 |
| RuBisCO | 0.25% | 1 |

The mixture was prepared as presented above. The RuBisCO was added with the lecithin to the melted coconut oil, wherein the subsequent mixture is combined as described for the control oil-in-water emulsions above. The resulting oil-in-water RuBisCO emulsion containing 1:1 RuBisCO:Lecithin exhibited a cottage cheese consistency, with grainy like components to the mixture.

TABLE 7
Exemplary Fat Replacement Formulation - Agar

| Ingredient | Percentage | Weight (grams) |
|---|---|---|
| Water | 79.8% | 319.2 |
| Agar | 1% | 4 |
| Coconut Oil | 19.5% | 78 |
| Lecithin | 0.25% | 1 |
| RuBisCO | 0.25% | 1 |

The mixture was prepared as presented above. The RuBisCO was added with the lecithin to the melted coconut oil, wherein the subsequent mixture is combined as described for the control oil-in-water emulsions above. The resulting oil-in-water RuBisCO emulsion containing 1:1 RuBisCO:Lecithin exhibited a stiff gel consistent with agar separating. The remaining emulsion exhibited a consistency similar to feta cheese. This emulsion melted easily, transforming into a clear gel.

TABLE 8
Exemplary Fat Replacement Formulation - Pectin

| Ingredient | Percentage | Weight (grams) |
|---|---|---|
| Water | 79.8% | 319.2 |
| Pectin | 0.8% | 3.2 |
| Coconut Oil | 19.5% | 78 |
| Lecithin | 0.25% | 1 |
| RuBisCO | 0.25% | 1 |

The mixture was prepared as presented above. The RuBisCO was added with the lecithin to the melted coconut oil, wherein the subsequent mixture is combined as described for the control oil-in-water emulsions above. The resulting oil-in-water RuBisCO emulsion containing 1:1 RuBisCO:Lecithin exhibited a grainy consistency similar to the curdlan emulsion. The emulsion did not successfully produce a gel, or solid material.

TABLE 5
Exemplary Fat Replacement Formulation - Kappa Carrengeenan

| Ingredient | Percentage | Weight (grams) |
|---|---|---|
| Water | 79.8% | 319.2 |
| Kappa Carrengeenan | 0.8% | 3.2 |
| Coconut Oil | 19.5% | 78 |
| Lecithin | 0.25% | 1 |
| RuBisCO | 0.25% | 1 |

The mixture was prepared as presented above. The RuBisCO was added with the lecithin to the melted coconut oil, wherein the subsequent mixture is combined as described for the control oil-in-water emulsions above. The resulting oil-in-water RuBisCO emulsion containing 1:1 RuBisCO:Lecithin exhibited a stiff flan consistency, similar to jell-o.

Additional oil-in-water emulsions were prepared with amounts of RuBisCO added to both the aqueous and oil phases prior to mixing. These higher concentration RuBisCO emulsions were thicker in comparison to the lower concentration RuBisCO emulsions.

### Example 9: Comparison of RuBisCO Emulsion Types

### Example 9.1: Emulsion Concentration Analysis

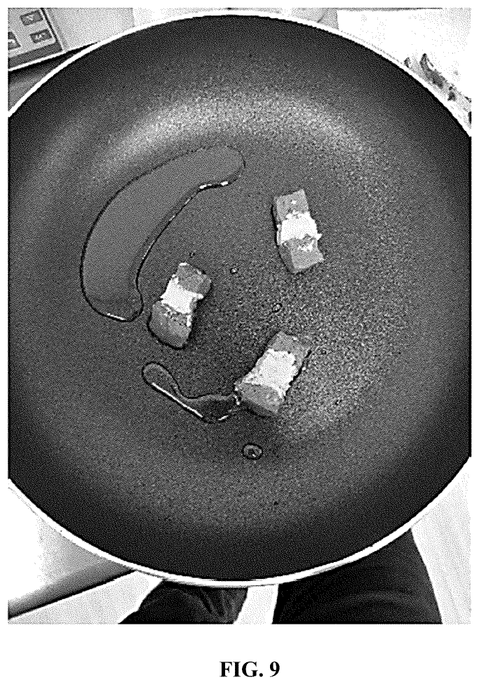

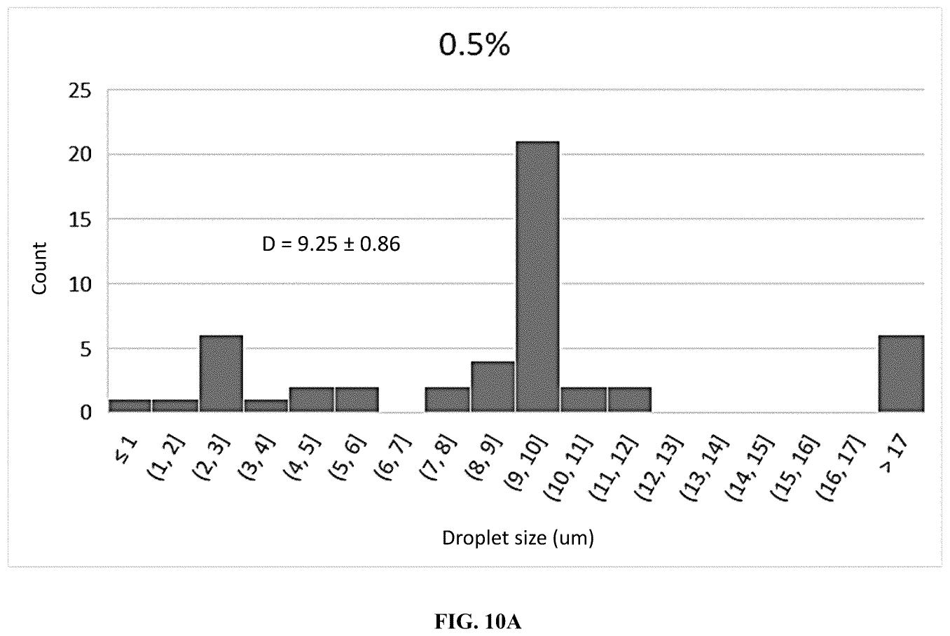

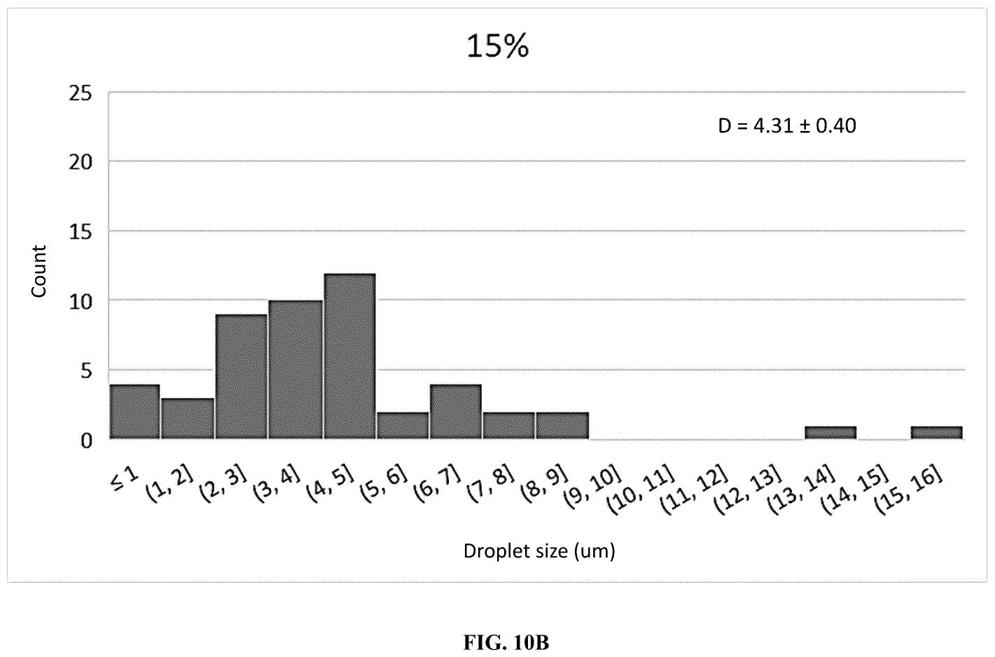

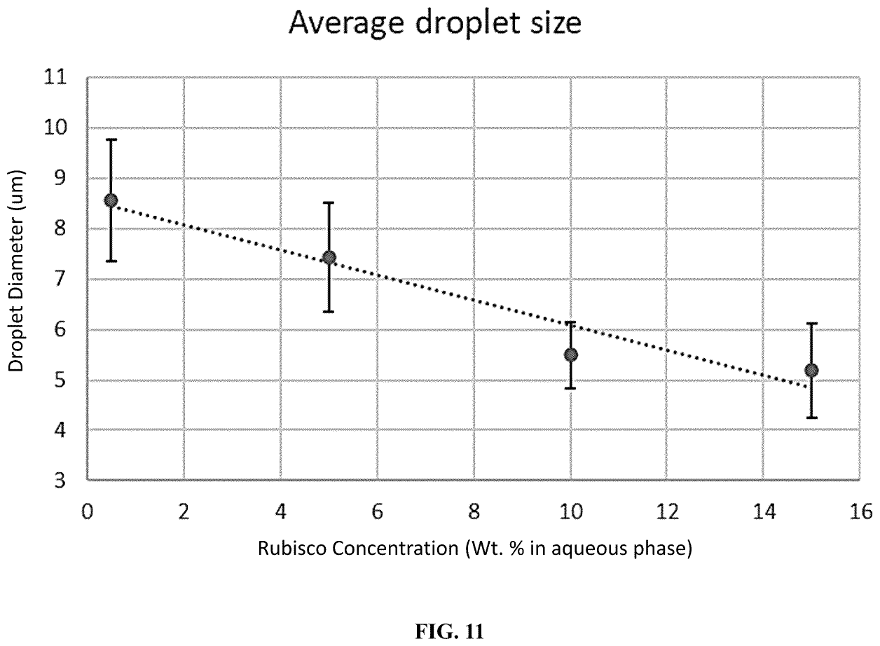

RuBisCO oil-in-water emulsions were prepared with 5% or 15% RuBisCO in 2 parts oil to 1 part water. The emulsions were homogenized on high speed for 2 minutes, with a 30-minute wait prior to analysis. Images were analyzed at 10-times magnification. The results showed that higher concentration RuBisCO emulsions produced smaller oil droplet sizes throughout the microstructure shown. Particle analysis was also conducted for the emulsions using 100-times magnification using a manual measurement tool in Fiji software. As shown in FIG. 10A-10B, a 30-times increase in RuBisCO concentration resulted in a 115% reduction in droplet size. Average droplet size was further conducted for 5% RuBisCO and 10% RuBisCO, with comparative images at 100-times magnification which showed that in comparing 0.5%, 5%, 10%, and 15% RuBisCO emulsions, the higher concentrations of RuBisCO in the emulsion resulted in a higher relative abundance in bubbles, and that bubble size decreases on average with higher RuBisCO concentration. A graphical analysis is provided as shown in FIG. 11.

### Example 10: Water-In-Oil RuBisCO Emulsions with Co-Surfactants

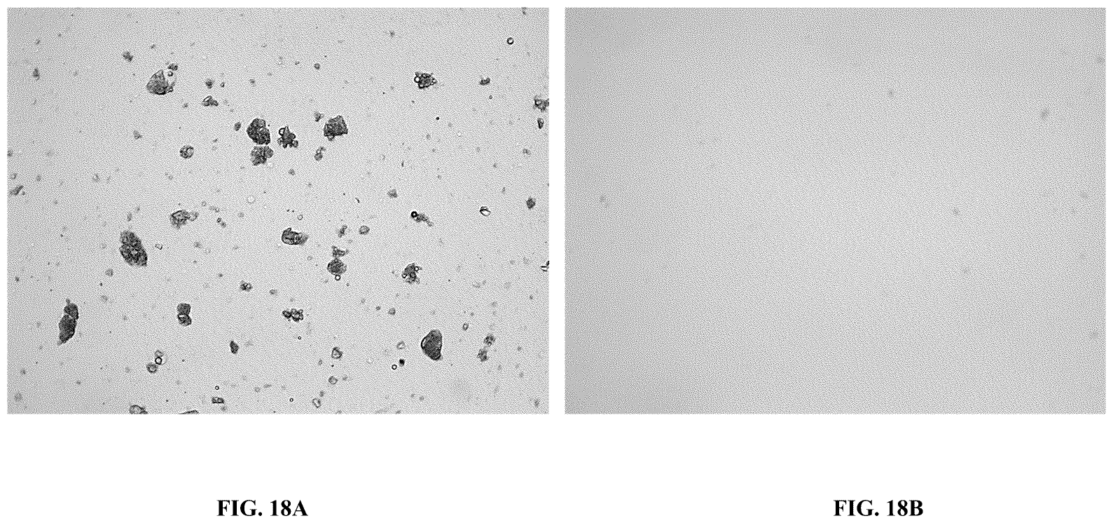

Water-in-oil emulsions were prepared comprising RuBisCO with sunflower lecithin prepared in water. A solution of 2% sunflower lecithin in water was analyzed before and after filtration with a 0.22 μM syringe filter. Brown specks shown in FIG. 18A (prefiltration) indicate that lecithin is not fully water soluble. Lecithin powder was completely insoluble in canola oil.

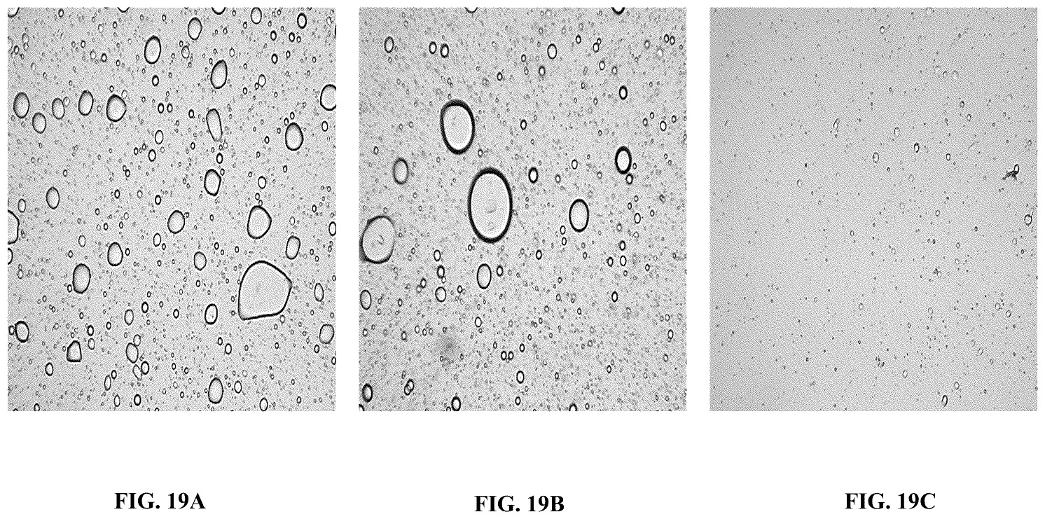

RuBisCO-containing emulsions comprising 90% oil and 10% water, with varied amounts of lecithin were analyzed for homogenization after an hour. Lecithin concentration consisted of about 0.5%, 1%, or 2% in the aqueous phase as shown in FIG. 19A-19C, respectively. The lecithin specks visible in the water only RuBisCO sample (FIG. 18A), were not visible in the emulsified solutions containing 90% oil. RuBisCO emulsion samples comprising 2% lecithin in the emulsion had relatively smaller emulsion bubbles, in comparison to the 0.5% and 1% formulations. The addition of lecithin to the RuBisCO water-in-oil emulsions showed from these analyses to be stabilizing for 10% water in oil formulations. Additional emulsions with varied oil to water ratios were compared. A RuBisCO emulsion comprising 30% water and 70% canola oil with 2% lecithin in the aqueous phase was not stable and broke during the waiting period of 30 minutes.

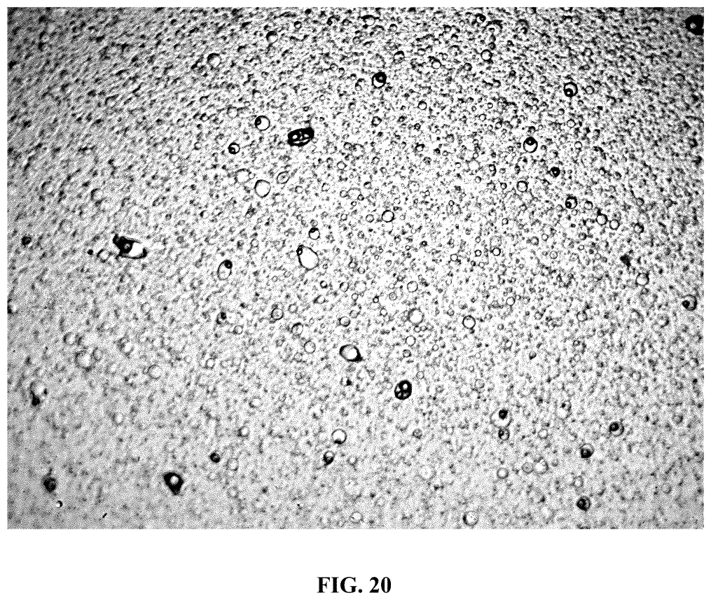

Lower percentage lecithin water-in-oil RuBisCO emulsions were prepared with 10% water (containing 0.5% by weight lecithin) with 90% canola oil (containing 5% by weight RuBisCO). This water-in-oil RuBisCO emulsion produced a heterogenous microstructure, with two distinct phases that were observable without magnification. as shown in FIG. 20.

Lower percentage lecithin water-in-oil RuBisCO emulsions can be prepared with higher percentages of water, for example with 20%, or 30% water. A 30% water (containing 0.5% by weight lecithin) lecithin water-in-oil RuBisCO emulsion with 90% canola oil (containing 5% by weight RuBisCO) was prepared with a homogenizer without phase separation.

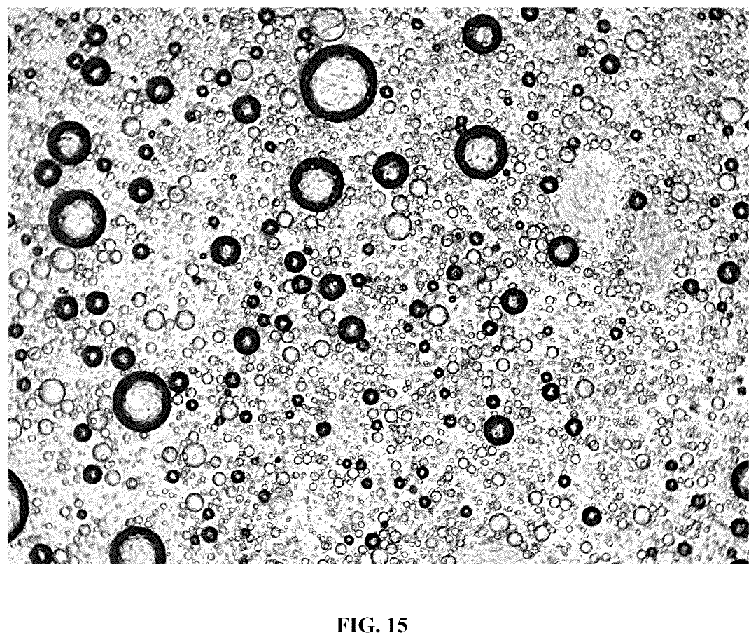

Further evidence of the emulsion stabilization provided by including lecithin is shown in FIG. 15, where varied concentrations of both RuBisCO and lecithin are examined for emulsion droplet size and homogeneity. FIG. 15 shows a magnified image of a RuBisCO emulsion comprising 90% coconut oil and 10% water with 5% RuBisCO concentration (% weight in the water) also comprising an amount of lecithin (0.5% by weight water).

Batch variability of the prepared emulsions was also considered and it was concluded that the standard procedure was reproducible between batches of preparing the emulsions.

### Example 11: Cooking with RuBisCO-Containing Emulsions

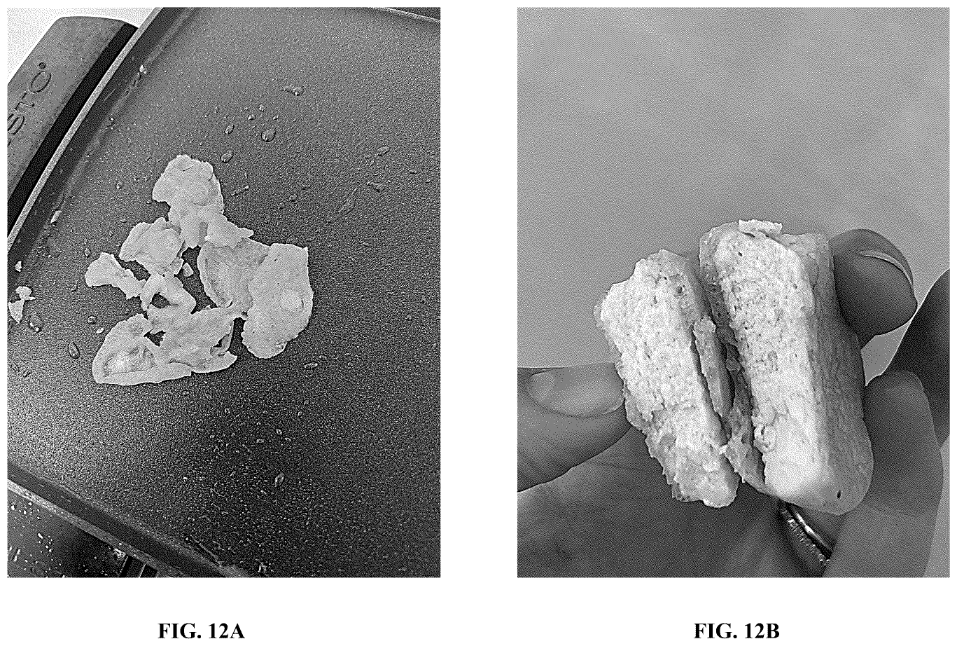

Emulsions comprised of 2 parts oil to 1 part water, containing RuBisCO were used for cooking. In comparing emulsions with different RuBisCO concentration, it was observed that viscosity and yielding of the cooked emulsion increased with RuBisCO concentration. The cooked emulsion consistency presented with strong yield stress and relatively high viscosity (thicker, more formed food product). Of note, emulsions with lower RuBisCO concentrations demonstrated less yield stress and relatively lower viscosities. The 5% RuBisCO and 10% RuBisCO emulsions had a slightly runny consistency in comparison to the 15% RuBisCO emulsion which, when cooked, presented with the highest yield stress strength and relatively high viscosity. These trends can be observed in FIG. 12A-12B which depict images of cooked RuBisCO emulsions comprising 2 parts oil to 1 part water, showing that viscosity and yielding of the cooked emulsion increases with RuBisCO concentration. FIG. 12A depicts an image of a cooked 5% RuBisCO (by weight % in the non-aqueous phase) emulsion. FIG. 12B depicts an image of a cooked 15% RuBisCO (by weight % of the non-aqueous phase) emulsion.

### Heating of RuBisCO) Emulsions

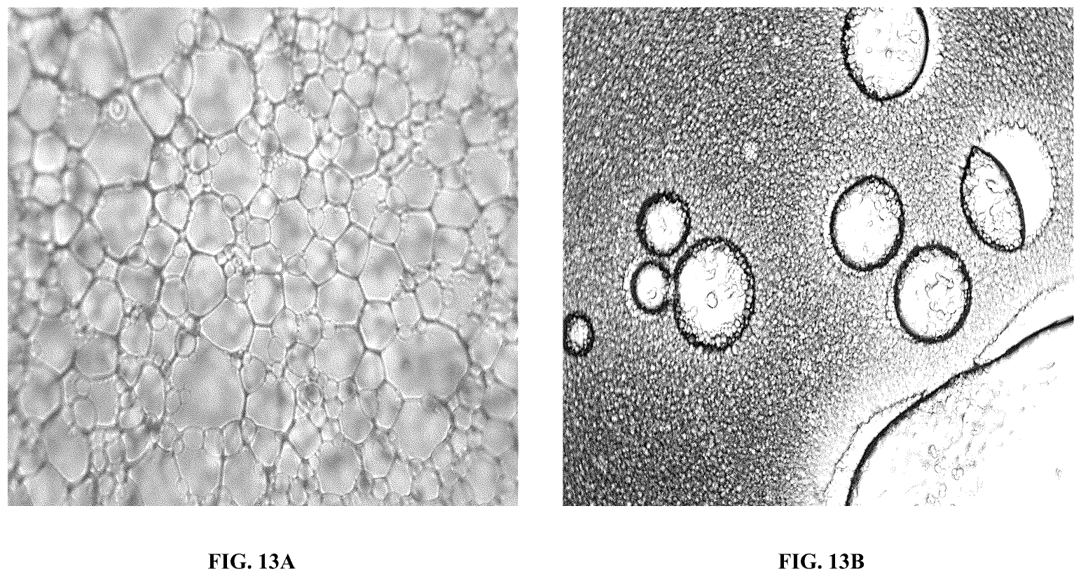

The RuBisCO emulsions comprising 2 parts oil to 1 part water were cooked by steaming (90° C.). The cooked 15% RuBisCO emulsion shows a more formed texture in comparison to the cooked 0.5% RuBisCO emulsion. FIGS. 13A-13B depict magnified images of 15% RuBisCO emulsions comprising 2 parts oil to 1 part water, where the emulsions were steamed at 90 degrees Celsius for 30 minutes, cooled to room temperature, and then were analyzed under magnification at 100-times magnification (FIG. 13A) and 10-times magnification (FIG. 13B). The emulsion bubbles are consistent with a slight loss of water during the heating process.

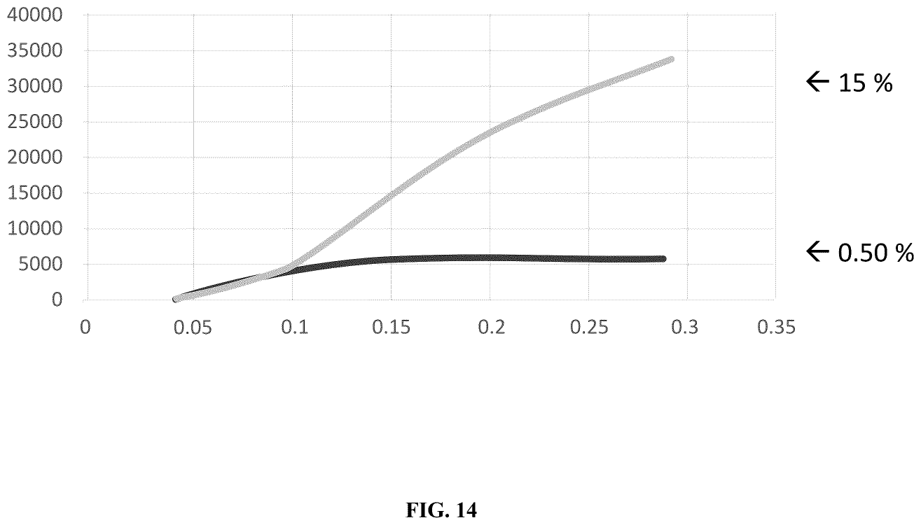

Texture analysis was performed for the 0.5% and 15% RuBisCO emulsions. FIG. 14 shows a graphical representation of texture analysis using stress (Pascals) as a function of displacement. Compressibility measured as stress was applied to steamed RuBisCO emulsions. The 15% RuBisCO emulsion (upper data series) demonstrated a gradual increase in stress as pressure was applied to the sample across approximately 0.275. The 0.5% RuBisCO emulsion demonstrated a lack of formed texture.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A composition, wherein the composition comprises water-in-oil emulsion particles, wherein the water-in-oil emulsion particles comprise:
a protein isolate, wherein a majority of the protein in the isolate is a ribulose-1,5-bisphosphate carboxylase/oxygenase (RuBisCO) protein isolate;
a lipid;
an aqueous liquid; and
a surfactant.

2. The composition of claim 1, wherein the surfactant comprises a plant-based surfactant.

3. The composition of claim 1, wherein the surfactant comprises lecithin.

4. The composition of claim 3, wherein the lecithin is from soybean, sunflower, and rapeseed.

5. The composition of claim 3, wherein the lecithin is present in an amount of up to about 2% by weight.

6. The composition of claim 1, wherein the water-in-oil emulsion particles comprises an average zeta potential surface charge more negative than at least about −30 mV.

7. The composition of claim 6, wherein the water-in-oil emulsion particles comprises an average zeta potential surface charge of −20 mV to −35 mV.

8. The composition of claim 1, wherein the water-in-oil emulsion particles comprise an average diameter of up to about 10 μm.

9. The composition of claim 1, wherein the water-in-oil emulsion particles comprise an average diameter of about 1 to about 5 μm.

10. The composition of claim 1, wherein the lipid is in liquid phase at 25 degrees Celsius.

11. The composition of claim 1, wherein the lipid comprises grapeseed oil, canola oil, sunflower oil, safflower oil, butter, peanut butter, cashew butter, coconut butter, coconut mana, coco butter, soybean oil, coconut oil, corn oil, olive oil, peanut oil, palm oil, or oil from beans.

12. The composition of claim 1, wherein the water-in-oil emulsion particles are in a ratio of lipid:aqueous liquid is at least 2:1 by weight.

13. The composition of claim 1, wherein the water-in-oil emulsion particles are in a ratio of lipid:aqueous liquid is at least about 8:1 by weight.

14. The composition of claim 1, wherein the RuBisCO is present in an amount of at least about 0.5% by dry weight.

15. The composition of claim 1, wherein the protein isolate present in an amount of up to about 15% by dry weight.

16. The composition of claim 1, wherein protein isolate is free of chlorophyll.

17. The composition of claim 1, wherein the protein isolate comprises a large subunit and a small subunit of RuBisCO protein.

18. The composition of claim 1, wherein the protein isolate comprises protein comprising a sequence at least 90% identical to any one of SEQ ID NO: 1 to SEQ ID NO: 10.

19. The composition of claim 18, wherein the protein isolate comprises proteins comprising sequence of SEQ ID NO: 1 and 2; SEQ ID NO: 3 and 4; SEQ ID NO: 5 and 6; SEQ ID NO: 7 and 8; or SEQ ID NO: 9 and 10.

20. The composition of claim 1, wherein the protein isolate is from a plant in the Lemna genus.

21. The composition of claim 1, wherein the protein isolate is from a Lemna minor.

22. The composition of claim 20, wherein the protein isolate is from a Lemna aequinoctialis, Lemna disperma, Lemna ecuadoriensis, Lemna gibba, Lemna japonica, Lemna minor, Lemna mimita, Lemna obscura, Lemna paucicostata, Lemna perpusilla, Lemna tenera, Lemna trisulca, Lemna turionifera, Lemna valdiviana, Lemna yungensis, Medicago sativa, Nicotiana sylvestris, Nicotiana tabacum, Spinacia oleracea, Beta vulgaris, Atriplex lentiformis, Pereskia aculeata, and Chlorella vulgaris.

23. The composition of claim 1, wherein in the protein isolate is from a single plant species.

24. The composition of claim 1, wherein the composition comprises a pH up to about 7.8.

25. The composition of claim 1, further comprising a plasticizer.

26. The composition of claim 25, wherein the plasticizer comprises a gum.

27. The composition of claim 26, wherein the gum is gum Arabic, a xanthan gum, a guar gum, or a locust bean gum.

28. The composition of claim 1, wherein the aqueous liquid is water.

29. The composition of claim 1, wherein the aqueous liquid comprises water and one or more acids.

30. The composition of claim 29, wherein the one or more acids comprises citric acid and/or ascorbic acid.


SEQUENCE LISTING (10 sequences)

SEQ ID NO: 1 - protein, 478 aa, synthetic construct
MSPQTETKASAGFKAGVKDYKLNYYTPEYETKDTDILAAFRVTPQPGVPPEEAGAAVAAESSTGTWTTVWTDGLTSLDRYKGRCYHIEPVAGEENQFIAYIAYPLDLFEEGSVTNMFTSIVGNVFGFKALRALRLEDLRIPPAYSKTFQGPPHGIQVERDKLNKYGRPLLGCTIKPKLGLSAKNYGRAVYECLRGGLDFTKDDENVNSQPFMRWRDRFLFCAEAIYKAQAETGEIKGHYLNATAGTCEEMIKRAVFARELGVPIVMHDYLTGGFTANTSLAYYCRDNGLLLHIHRAMHAVIDRQKNHGMHFRVLAKALRMSGGDHVHSGTVVGKLEGEREMTLGFVDLLRDDFIEKDRSRGIFFTQDWVSMPGVLPVASGGIHVWHMPALTEIFGDDSVLQFGGGTLGHPWGNAPGAVANRVALEACVKARNEGRDLAREGNEIIREACNWSPELAAACEVWKEIKFEYEPVDKLDVK

SEQ ID NO: 2 - protein, 177 aa, synthetic construct
MASSMMASTAAAVARAGPAQSSMVPFNACRSSVPFPATRKANNNLSTLPGNGGRVSCMQVWPPEGLKKFETLSYLPPLSVEDLAKEVDYLLRNDWVPCIEFSKEGFVYRENHASPGYYDGRYWTMWKLPMFGCTDASQVIAEVEEAKKAYPEYFVRIIGFDNKRQVQCISFIAYKPT

SEQ ID NO: 3 - protein, 477 aa, synthetic construct
MSPQTETKASVGFKAGVKEYKLTYYTPEYQTKDTDILAAFRVTPQPGVPPEEAGAAVAAESSTGTWTTVWTDGLTSLDRYKGRCYRIERVVGEKDQYIAYVAYPLDLFEEGSVTNMFTSIVGNVFGFKALRALRLEDLRIPPAYVKTFQGPPHGIQVERDKLNKYGRPLLGCTIKPKLGLSAKNYGRAVYECLRGGLDFTKDDENVNSQPFMRWRDRFLFCAEALYKAQAETGEIKGHYLNATAGTCEEMIKRAVFARELGVPIVMHDYLTGGFTANTSLAHYCRDNGLLLHIHRAMHAVIDRQKNHGIHFRVLAKALRMSGGDHIHSGTVVGKLEGERDITLGFVDLLRDDFVEQDRSRGIYFTQDWVSLPGVLPVASGGIHVWHMPALTEIFGDDSVLQFGGGTLGHPWGNAPGAVANRVALEACVKARNEGRDLAQEGNEIIREACKWSPELAAACEVWKEIVFNFAAVDVLDK

SEQ ID NO: 4 - protein, 181 aa, synthetic construct
MAFLIMSSAAAVATGTNAAQASMIAPFTGLKSATSFPVSRKQNLDITSIASNGGRVQCMQVWPPINKKKYETLSYLPDLSEEQLLREVEYLLKNGWVPCLEFETEHGFVYRENNKSPGYYDGRYWTMWKLPMFGCTDATQVLAEVEEAKKAYPQAWIRIIGFDNVRQVQCISFIAYKPEGY

SEQ ID NO: 5 - protein, 474 aa, synthetic construct
MSPQTETKATVGFKAGVKDYRLTYYTPDYETKDTDILAAFRVSPQPGVPAEEAGAAVAAESSTGTWTTVWTDGLTSLDRYKGRCYHIEPVAGEETQFIAYVAYPLDLFEEGSVNYMFTSIVGNVFGFKALRALRLEDLRIPAAYVKTFQGPPQGIQVERDKLNKYGRPLLGCTIKPKLGLSAKNYGRAVYECLRGGLDFTKDDENVNSQPFMRWRDRFLFCAEAIYKAQAETGEIKGHYLNATAGTCEEMMKRAVFARELGVPIVMHDYLTVGFTANTTLAHYCRDNGLLLHIHRAMHAVIDRQKNHGMHFRVLAKALRMSGGDHIHAGTVVGKLEGERDITLGFVDLLRDDFIEKDRSRGIFFTQDWVSLPGVLPVASGGIHVWHMPALTEIFGDDSVLQFGGGTLGHPWGNAPGAVANRVALEACVQARNEGRDLAREGNEIIREATKWSPELAAACEVWKEIKFEFPAMDN

SEQ ID NO: 6 - protein, 180 aa, synthetic construct
MALISSAAVTTVNRASSAQANLVAPFTGLKSSAGFPVTKKTNNDITSIASNGGRVNCMQVWPPVGKKKFETLSYLPPLTEEQLAKEVEYLIRKGWIPCLEFELEKGFVYRENHRSPGYYDGRYWTMWRLPLFGATDSSQVLKELADCKAEYPDSFIRIIGFDNVRQVQCISFIAHTPKNY

SEQ ID NO: 7 - protein, 475 aa, synthetic construct
MSPQTETKASVEFKAGVKDYKLTYYTPEYETLDTDILAAFRVSPQPGVPPEEAGAAVAAESSTGTWTTVWTDGLTNLDRYKGRCYHIEPVAGEENQYICYVAYPLDLFEEGSVTNMFTSIVGNVFGFKALRALRLEDLRIPVAYVKTFQGPPHGIQVERDKLNKYGRPLLGCTIKPKLGLSAKNYGRAVYECLRGGLDFTKDDENVNSQPFMRWRDRFLFCAEALYKAQAETGEIKGHYLNATAGTCEDMMKRAVFARELGVPIVMHDYLTGGFTANTTLSHYCRDNGLLLHIHRAMHAVIDRQKNHGMHFRVLAKALRLSGGDHIHSGTVVGKLEGERDITLGFVDLLRDDYTEKDRSRGIYFTQSWVSTPGVLPVASGGIHVWHMPALTEIFGDDSVLQFGGGTLGHPWGNAPGAVANRVALEACVQARNEGRDLAREGNTIIREATKWSPELAAACEVWKEIKFEFPAMDTV

SEQ ID NO: 8 - protein, 123 aa, synthetic construct
MQVWPPLGLKKFETLSYLPPLTTEQLLAEVNYLLVKGWIPPLEFEVKDGFVYREHDKSPGYYDGRYWTMWKLPMFGGTDPAQVVNEVEEVKKAPPDAFVRFIGFNDKREVQCISFIAYKPAGY

SEQ ID NO: 9 - protein, 475 aa, synthetic construct
MSPQTETKARVGFKAGVKDYRLTYYTPDYQPKDTDILAAFRMTPQPGVPPEEAGAAVAAESSTGTWTTVWTDGLTSLDRYKGRCYDIEPVPGEENQYIAYIAYPLDLFEEGSVTNLFTSIVGNVFGFKALRALRLEDLRIPPAYVKTFQGPPHGIQVERDKLNKYGRGLLGCTIKPKLGLSAKNYGRAVYECLRGGLDFTKDDENVNSQPFMRWRDRFLFVAEAIYKSQAETGEIKGHYLNATAATAEAMMQRAECAKDLGVPIIMHDYLTGGFTANTSLSHYCRDNGLLLHIHRAMHAVIDRQRNHGITFRVLAKALRLSGGDHLHSGTVVGKLEGEREVTLGFVDLMRDDYIEKDRSRGIYFTQDWVSLPGTMPVASGGIHVWHMPALVEIFGDDACLQFGGGTLGHPWGNAPGAAANRVALEACTQARNEGRDLAREGGDVIRAACKWSPELAAACEVWKEIKFEFETIDTL

SEQ ID NO: 10 - protein, 214 aa, synthetic construct
MAALTASLVSCPVAVAAKPARLASPAWPASLSPRRLSPPSPRGPSQTAAAPARCSCGSPLTTSSSRPSPTCPSDRRPDRQAGRLHHPSGWTPALEFSNAESAYVKDVANIRFTGGSASCNYYDNRYWAMYKLPMFGCTDASQVLAEIANAVKTFPDSYVRMAAFDAVRQVQTVAILVHRPASATDYRLPENPQPLIGCTTQLERPQYCKSLANL